(19) United States
(12) Patent Application Publication
(10) Pub. No.: US 2023/0274924 A1
(43) Pub. Date: Aug. 31, 2023

(54) METHOD AND APPARATUS OF MASS ANALYSING POSITIVELY CHARGED IONS AND NEGATIVELY CHARGED IONS

(71) Applicant: TOFWERK AG, Thun (CH)

(72) Inventors: Urs ROHNER, Thun (CH); Felipe LOPEZ-HILFIKER, Steffisburg (CH)

(73) Assignee: TOFWERK AG, Thun (CH)

(21) Appl. No.: 18/114,674

(22) Filed: Feb. 27, 2023

(30) Foreign Application Priority Data
Feb. 28, 2022 (EP) 22 159 219.9

(51) Int. Cl. H01J 49/00; H01J 49/40

(52) U.S. Cl. CPC H01J 49/0095; H01J 49/401; H01J 49/0031

(57) ABSTRACT

The invention relates to a method for mass analysing positively charged ions and negatively charged ions with a mass analyser arrangement (10). The method includes inserting the positively charged ions and the negatively charged ions via an intake (13) of the mass analyser arrangement (10) into a mass analysis chamber (14) of the mass analyser arrangement (10). Furthermore, the method includes transferring inside the mass analysis chamber (14) the positively charged ions from the intake (13) to a first mass analyser (11) of the mass analyser arrangement (10) and mass analysing the positively charged ions with the first mass analyser (11) and transferring inside the mass analysis chamber (14) the negatively charged ions from the intake (13) to a second mass analyser (12) of the mass analyser arrangement (10) and mass analysing the negatively charged ions with the second mass analyser (12). The invention furthermore relates to the mass analyser arrangement (10) for mass analysing positively charged ions and negatively charged ions with the method according to the invention.

### TECHNICAL FIELD

The invention relates to a method for mass analysing positively charged ions and negatively charged ions with a mass analyser arrangement and a mass analyser arrangement for mass analysing positively charged ions and negatively charged ions with the method according to the invention.

### BACKGROUND ART

Methods and mass analyser arrangements pertaining to the technical field initially mentioned are known. In the context of such methods and mass analysers, the term mass analysing is used for determining the mass analysed ions' mass per charge ratio, often referred to as m/q-ratio or shorter m/q. Often, the unit Th is used for indicating the mass to charge ratio of ions. Th is the abbreviation of Thomson, wherein one Thomson is one unified atomic mass unit divided by one elementary charge. One unified atomic mass unit is 1.66053906660×10⁻²⁷ kg, while one elementary charge is 1.602176634×10⁻¹⁹ C.

Mass analysing ions, be it positively charged ions or negatively charged ions, is performed by separating the ions according to their mass per charge ratio and by obtaining a so-called mass spectrum. Such a mass spectrum with its data points provides information on the distribution of the mass analysed ions with respect to the ions' mass per charge ratio. In order to provide this information, the data points are not required to express the exact number of ions having the respective mass per charge ratio or being within the particular range of mass per charge ratios assigned to the respective data point. Rather, it is sufficient for the data points to provide a number which is proportional to the exact quantity, thus indicating the number of ions. Thus, each data point in the mass spectrum may be a single number. In this case, each single number indicates the number of ions having a mass per charge ratio matching the particular mass per charge ratio or being within the particular range of particular mass per charge ratios assigned to the respective data point. In a variant, each data point in the mass spectrum may comprise two numbers. In this case, a first number of each data point indicates the number of ions having the mass per charge ratio matching the particular mass per charge ratio or being within the particular range of mass per charge ratios assigned to the respective data point, while a second number of each data point indicates the mass per charge ratio or range of mass per charge ratios the respective data point is assigned to.

One example of a method and a mass analyser arrangement pertaining to the technical field initially mentioned is described in WO 99/18595 A1 of The Regents of the University of California. This document discloses a mass spectrometer for determining the composition of particles suspended in an aerosol. The spectrometer is a dual time-of-flight mass spectrometer including a mass analyser arrangement with two time-of-flight mass analysers, each arranged at another one of two nearly symmetrical ends of the spectrometer. These two time-of-flight mass analysers are adapted to process positively charged ions and negatively charged ions, respectively. The spectrometer is contained within a metal housing and has a common ion source region, but the two ends of the spectrometer are biased separately negatively and positively in order to separately process positively charged ions and negatively charged ions. In operation, the particles are inserted into the common ion source region where a pulsed laser is aimed at a dissociation point. When a particle reaches the dissociation point inside the common ion source region, the pulsed laser irradiates the particle with an intensity sufficiently high to ionise a substantial fraction of the desorbed molecules to positively charged ions and negatively charged ions. These positively charged ions are then accelerated to one end of the spectrometer for being mass analysed with the mass analyser arranged at this one end of the spectrometer, while the negatively charged ions are accelerated to the other end of the spectrometer for being mass analysed with the mass analyser being arranged at this other end of the spectrometer.

Such known methods and mass analyser arrangements have the disadvantage that the space where the ions are generated is very limited, leaving only limited freedom to the ionisation method used for generating the positively charged ions and the negatively charged ions.

In the present text, the formulation “and/or” is occasionally used for linking two features. This formulation is to be understood as either one of the two features or both of the features. Thus, “A and/or B” is to be understood as three equivalent options, wherein one option is A, another option is B and yet another option is both A and B.

### SUMMARY OF THE INVENTION

It is the object of the invention to create a method and a mass analyser arrangement pertaining to the technical field initially mentioned, that provide more freedom to the ionisation method used for generating the positively charged ions and the negatively charged ions.

The solution of the invention is specified by the features of claim 1. According to the invention, the method includes inserting the positively charged ions and the negatively charged ions via an intake, in particular exactly one intake, of the mass analyser arrangement into a mass analysis chamber of the mass analyser arrangement, and transferring inside the mass analysis chamber the positively charged ions from the intake to a first mass analyser of the mass analyser arrangement and mass analysing the positively charged ions with the first mass analyser and transferring inside the mass analysis chamber the negatively charged ions from the intake to a second mass analyser of the mass analyser arrangement and mass analysing the negatively charged ions with the second mass analyser.

Furthermore, according to the invention, the mass analyser arrangement for mass analysing positively charged ions and negatively charged ions with the method according to the invention includes a first mass analyser for mass analysing the positively charged ions, a second mass analyser for mass analysing the negatively charged ions, and an intake, in particular exactly one intake, for inserting the positively charged ions and the negatively charged ions into a mass analysis chamber of the mass analyser arrangement for mass analysing the positively charged ions with the first mass analyser and for mass analysing the negatively charged ions with the second mass analyser, wherein the intake is fluidly coupled with the first mass analyser for transferring the positively charged ions from the intake to the first mass analyser for mass analysing the positively charged ions and wherein the intake is fluidly coupled with the second mass analyser for transferring the negatively charged ions from the intake to the second mass analyser for mass analysing the negatively charged ions.

According to the invention, the mass analyser arrangement is for mass analysing positively charged ions and negatively charged ions. Thus, the mass analyser arrangement is a bipolar mass analyser arrangement.

The method and the mass analyser arrangement according to the invention have the advantage that the positively charged ions and the negatively charged ions are inserted into the same mass analysis chamber for being mass analysed. Thus, the positively charged ions and the negatively charged ions are generated by ionisation of one or more samples outside of the mass analysis chamber which provides more freedom to the ionisation method used for generating the positively charged ions and the negatively charged ions. Thereby, the positively charged ions and the negatively charged ions can be inserted into the mass analysis chamber through one and the same intake or can be inserted into the mass analysis chamber through separate intakes. In case of separate intakes, the above mentioned intake are advantageously two separate intakes. In an example, the two separate intakes are arranged adjacent to each other. In another example, the two separate intakes are arranged distanced from each other. Particular advantageously, the positively charged ions and the negatively charged ions are inserted into the mass analysis chamber through one and the same intake. In this case, the above mentioned intake is actually the above mentioned exactly one intake.

Advantageously, insertion of the positively charged ions and the negatively charged ions via the intake into the mass analysis chamber is controlled with a switchable ion gate of the mass analyser arrangement, wherein the switchable ion gate is arranged in front of the intake and thus outside of the mass analysis camber in an ion path of the positively charged ions and the negatively charged ions leading into the mass analysis chamber. Thereby, in case the intake extends over a length along the ion path leading into the mass analysis chamber, the switchable ion gate can be located inside the intake, as long as it is arranged outside of the mass analysis chamber. This has the advantage that the insertion of the positively charged ions and the negatively charged ions into the mass analysis chamber can be controlled in a very efficient and effective way.

Advantageously, the insertion of the positively charged ions and the negatively charged ions via the intake into the mass analysis chamber is controlled with the switchable ion gate of the mass analyser arrangement, wherein the switchable ion gate is arranged in front of the intake and thus outside of the mass analysis camber in the ion path of the positively charged ions and the negatively charged ions leading into the mass analysis chamber, wherein the switchable ion gate is switched between a positive ions insertion mode where the positively charged ions are allowed to pass through the intake into the mass analysis chamber while the negatively charged ions are prevented from passing through the intake into the mass analysis chamber, and a negative ions insertion mode where the negatively charged ions are allowed to pass through the intake into the mass analysis chamber while the positively charged ions are prevented from passing through the intake into the mass analysis chamber. This has the advantage that both, the insertion of only the positively charged ions as well as the insertion of only the negatively charged ions into the mass analysis chamber can be controlled in a very efficient and effective way. Thereby, the switchable ion gate is advantageously operated by applying an ion gate voltage to the switchable ion gate, the ion gate voltage having an absolute value of less than 20 V. In a variant, however, the switchable ion gate is operated by applying an ion gate voltage to the switchable ion gate, the ion gate voltage having an absolute value of 20 V or more. Advantageously, for switching the switchable ion gate between the positive ions insertion mode and the negative ion insertion mode, a sign of the ion gate voltage applied to the switchable ion gate is reversed, wherein in both the positive ion insertion mode and the negative ion insertion mode, the ion gate voltage has an absolute value in a range from 1 V to about 10 V, particular advantageously from 1 V to about 5 V. Thereby, the absolute value of the ion gate voltage may be the same in both the positive ion insertion mode and the negative ion insertion mode or may differ in the positive ion insertion mode as compared to in the negative ion insertion mode.

Preferably, the switchable ion gate is switched between the positive ions insertion mode and the negative ions insertion mode and back within 100 ms or less, preferably within 20 ms or less, particular preferably within 10 ms or less, more preferably within 200 μs or less, even more preferably within 50 μs or less, and most preferably within 15 μs or less.

Switching between the positive ions insertion mode and the negative ions insertion mode and back within 100 ms or less has the advantage that the method for mass analysing the positively charged ions and the negatively charged ions enables a time resolved mass analysis of positively charged ions and negatively charged ions obtained by ionisation from an output of a gas chromatography column, wherein the time resolution is sufficient for obtaining the gas chromatogram from the gas chromatography column, too. Switching between the positive ions insertion mode and the negative ions insertion mode and back within 20 ms or less has the advantage that the method for mass analysing the positively charged ions and the negatively charged ions enables a time resolved mass analysis of positively charged ions and negatively charged ions obtained by ionisation from an output of a fast gas chromatography column, wherein the time resolution is sufficient for obtaining the gas chromatogram from the fast gas chromatography column, too. Furthermore, switching between the positive ions insertion mode and the negative ions insertion mode and back within 20 ms or less has the advantage that the method for mass analysing the positively charged ions and the negatively charged ions enables a time resolved mass analysis of positively charged ions and negatively charged ions obtained by ionisation from a gaseous sample at atmospheric pressure, wherein the time resolution is sufficient for resolving changes in the gaseous sample, too. Switching between the positive ions insertion mode and the negative ions insertion mode and back within 10 ms or less has the advantage that the method for mass analysing the positively charged ions and the negatively charged ions enables a time resolved mass analysis of positively charged ions and negatively charged ions obtained by ionisation from an output of an ion molecule reactor at a pressure of 50 mbar, wherein the time resolution is sufficient for resolving changes in the output of the ion molecule reactor, too. Switching between the positive ions insertion mode and the negative ions insertion mode and back within 200 μs or less has the advantage that the method for mass analysing the positively charged ions and the negatively charged ions enables a time resolved mass analysis of positively charged ions and negatively charged ions where at least one of the positively charged ions and the negatively charged ions are separated according to their mobility in an ion mobility separation chamber, wherein the time resolution is sufficient for obtaining the ion mobility spectrum of the positively charged ions and/or negatively charged ions, respectively, too. Switching between the positive ions insertion mode and the negative ions insertion mode and back within 50 μs or less, in particular or 15 μs or less, has the advantage that the method for mass analysing the positively charged ions and the negatively charged ions enables obtaining with a high time resolution and very high time resolution, respectively, for analysing any time dependent changes in a sample. Too short switching times however may become disadvantageous as well. For example, the switchable ion gate is advantageously switched between the positive ions insertion mode and the negative ions insertion mode and back after a longer time period than 10 μs, particular advantageously after a longer time period than 32 μs. Switching between the positive ions insertion mode and the negative ions insertion mode and back after a longer time period than 10 μs has the advantage that this time is sufficient for obtaining with a time-of-flight mass analyser a mass spectrum from 0 Th to at least 300 Th, such that in case the first mass analyser is a time-of-flight mass analyser, mass spectra from 0 Th to at least 300 Th can be obtained from the positively charged ions, while in case the second mass analyser is a time-of-flight mass analyser, mass spectra from 0 Th to at least 300 Th can be obtained from the negatively charged ions. Switching between the positive ions insertion mode and the negative ions insertion mode and back after a longer time period than 32 μs has the advantage that this time is sufficient for obtaining with a time-of-flight mass analyser a mass spectrum from 0 Th to at least 3'000 Th, such that in case the first mass analyser is a time-of-flight mass analyser, mass spectra from 0 Th to at least 3'000 Th can be obtained from the positively charged ions, while in case the second mass analyser is a time-of-flight mass analyser, mass spectra from 0 Th to at least 3'000 Th can be obtained from the negatively charged ions.

Thereby, in correspondence to these switching times, the switchable ion gate is advantageously operated at a switching rate of 10 Hz or more, 50 Hz or more, 100 Hz or more, 5 kHz or more, 20 kHz or more, or 66.6667 kHz or more, respectively. Thereby, the switchable ion gate is advantageously switched in a sequence comprising elements of positive ions insertion mode and elements of negative ions insertion mode, wherein each element has a length of the mentioned 100 ms or less, 20 ms or less, 10 ms or less, 200 μs or less, 50 μs or less, or 15 μs or less, respectively. Thereby, in the sequence, the elements of positive ions insertion mode and the elements of negative ions insertion mode may alternate or may be arranged in any other pattern like for example in a repeated subsequence of two elements of positive ions insertion mode followed by one element of negative ions insertion mode. Alternatively to these switching rates, the switchable ion gate can operated at a lower switching rate like for example 1 Hz, 0.1 Hz, 0.01 Hz, 0.004 Hz or even less. These switching rates correspond to longer switching times which correspond to a switching of the switchable ion gate in a sequence comprising elements of positive ions insertion mode and elements of negative ions insertion mode, wherein each element has a length of the mentioned 1 s, 10 s, 100 s and 250 s, respectively.

Preferably, the method according to the invention for mass analysing positively charged ions and negatively charged ions with a mass analyser arrangement is employed in a method for mass analysing a sample. In such a method for mass analysing a sample, the sample is ionised with at least one ion source to positively charged ions and negatively charged ions, wherein the positively charged ions and the negatively charged ions are mass analysed with the method according to the invention for mass analysing positively charged ions and negatively charged ions with a mass analyser arrangement. Thereby, for ionising the sample with the at least one ion source to positively charged ions and negatively charged ions, it is irrelevant whether the sample is ionised to the positively charged ions and to the negatively charged ions with one and the same ions source or whether an assay of the sample is ionised with one ion source to the positively charged ions and another assay of the sample is ionised with another ion source to the negatively charged ions. In case the sample is ionised to the positively charged ions and to the negatively charged ions with one and the same ion source, the ion source can for example be a laser ablation ion source, a matrix-assisted laser desorption/ionisation (MALDI) ion source, a surface-enhanced laser desorption ionisation (SELDI) ion source, an electrospray ionisation (ESI) ion source, an electron impact (EI) ion source, a secondary ion source, a fast atom bombardment (FAB) ion source, or a chemical ionisation (Cl) ion source. In case an assay of the sample is ionised with one ion source to the positively charged ions and another assay of the sample is ionised with another ion source to the negatively charged ions, the ion sources can be any of the before mentioned ion sources or any ion source which generates only positively charged ions or only negatively charged ions, respectively. For example, each one of the ion sources can be any one of a Plasma ion source like for example an inductively coupled plasma (ICP) ion source or a microwave induced plasma (MIP) ion source, an extractive electrospray ionisation (EESI) ion source or an atmospheric pressure photoionisation (APPI) ion source.

Advantageously, in the method for mass analysing a sample, the at least one ion source is part of an apparatus for mass analysing a sample, wherein the apparatus includes the mass analyser arrangement according to the invention employed in the method according to the invention for mass analysing the positively charged ions and the negatively charged ions with the mass analyser arrangement. In this case, in the method for mass analysing a sample, the sample is advantageously ionised with at least one ion source of the apparatus for mass analysing the sample to positively charged ions and negatively charged ions, wherein the positively charged ions and the negatively charged ions are mass analysed with the mass analyser arrangement of the apparatus with the method according to the invention for mass analysing positively charged ions and negatively charged ions with a mass analyser arrangement.

Thus, advantageously, an apparatus is provided for mass analysing a sample with the method for mass analysing a sample. This apparatus includes at least one ion source for ionising the sample to positively charged ions and negatively charged ions and the mass analyser arrangement according to the invention for mass analysing positively charged ions and negatively charged ions with the mass analyser arrangement, the mass analyser arrangement including the first mass analyser, the second mass analyser and the intake for inserting the positively charged ions and the negatively charged ions into the mass analysis chamber of the mass analyser arrangement, wherein the at least one ion source is fluidly coupled to the intake for transferring the positively charged ions and the negatively charged ions, respectively, from the at least one ion source to the intake for inserting the positively charged ions and the negatively charged ions into the mass analysis chamber of the mass analyser arrangement for enabling the mass analysis of the positively charged ions with the first mass analyser and for enabling the mass analysis of the negatively charged ions with the second mass analyser.

The method for mass analysing a sample and the apparatus for mass analysing a sample with the method for mass analysing a sample have the advantage that a very effective way for mass analysing a sample where positively charged ions and negatively charged ions are obtained from the sample and thus for mass analysing the sample bipolarly are provided.

Preferably, the mass analyser arrangement includes a chamber housing surrounding the mass analysis chamber. This has the advantage that the inside of the mass analysis chamber can be well separated from the outside of the mass analysis chamber. Furthermore, the chamber housing has the advantage that, depending on how the chamber housing is constructed, achieving and maintaining in the mass analysis chamber a reduced pressure as compared to atmospheric pressure can easily be enabled. Thereby, the first mass analyser and the second mass analyser can be arranged completely inside the chamber housing of the mass analysis chamber or can themselves form parts of the chamber housing of the mass analyser arrangement, e.g. parts of a housing of the first mass analyser and parts of a housing of the second mass analyser can form parts of the chamber housing.

Advantageously, the mass analyser arrangement includes at least one transfer electrode for generating an electric field, in particular an electrostatic field, for transferring the positively charged ions inside the mass analysis chamber from the intake to the first mass analyser for being mass analysed with the first mass analyser and for transferring the negatively charged ions inside the mass analysis chamber from the intake to the second mass analyser for being mass analysed with the second mass analyser. Thereby, the electric field generatable by the at least one transfer electrode can for example be the mentioned electrostatic field. However, the electric field generatable by the at least one transfer electrode can as well be an electric field which changes over time. For example, it can be a pure AC electromagnetic field or an electrostatic field with a superimposed AC electromagnetic field.

The at least one transfer electrode for generating an electrostatic field has the advantage that inside the mass analysis chamber, the positively charged ions and the negatively charged ions can be transferred by an electrostatic field to the first mass analyser and the second mass analyser, respectively, such that no switching of electric fields is required inside the mass analysis chamber for transporting the positively charged ions inside the mass analysis chamber to the first mass analyser and the negatively charged ions to the second mass analyser. Consequently, no changing electric fields are required inside the mass analysis chamber for transferring the ions which would disturb the operation of the first mass analyser and the operation of the second mass analyser. Therefore, the mass analyser arrangement according to the invention enables a more precise bipolar mass analysis of positively charged ions and negatively charged ions. This advantage can even be achieved in case weak changing electric fields are generated with the transfer electrode since weak changing electric fields only marginally disturb the operation of the first mass analyser and the operation of the second mass analyser.

Advantageously, the at least one transfer electrode is for generating the electric field or electrostatic field, respectively, for transferring the positively charged ions into a first mass analyser ion inlet of the first mass analyser for being mass analysed with the first mass analyser and for transferring the negatively charged ions into a second mass analyser ion inlet of the second mass analyser for being mass analysed with the second mass analyser. This has the advantage that the first mass analyser is well separated from the remaining mass analysis chamber and that the second mass analyser is well separated from the remaining mass analysis chamber. Thus, an improvement of the signal to noise ratio in the mass spectra obtained with the first mass analyser and the second mass analyser can be achieved.

Alternatively, the first mass analyser and the second mass analyser do not provide an inlet for inserting the positively charged ions into the first mass analyser and the negatively charged ions into the second mass analyser. This can for example be the case when the first mass analyser and the second mass analyser each consist of separated components arranged in the mass analysis chamber without defining clearly an inside of the first mass analyser or an inside of the second mass analyser, respectively, such that no clear defined inlet of the first mass analyser and no clear defined inlet of the second mass analyser exists.

Advantageously, the at least one transfer electrode is arranged inside the mass analysis chamber. In case the mass analyser arrangement includes the above mentioned chamber housing surrounding the mass analysis chamber, the at least one transfer electrode is advantageously arranged inside the chamber housing of the mass analysis chamber. This has the advantage that the electric field generatable with the at least one transfer electrode can be generated very localised along the path along which the positively charged ions are transferred from the intake to first mass analyser and along the path along which the negatively charged ions are transferred from the intake to the second mass analyser. Thus, any disturbance of the operation of the first mass analyser and the operation of the second mass analyser by the electric field generated with the at least one transfer electrode is minimised. This advantage can be further increased when the at least one transfer electrode is arranged in a space between the intake, the first mass analyser and the second mass analyser in the mass analysis chamber.

In an alternative, however, the at least transfer electrode is arranged outside of the mass analysis chamber.

In the context of the at least one transfer electrode, it is to be mentioned that in the method for mass analysing the positively charged ions and the negatively charged ions, advantageously, the electric field, in particular the electrostatic field, is generated with the at least one transfer electrode, for transferring the positively charged ions inside the mass analysis chamber from the intake to the first mass analyser for being mass analysed with the first mass analyser and for transferring the negatively charged ions inside the mass analysis chamber from the intake to the second mass analyser for being mass analysed with the second mass analyser.

Alternatively to these variants with the at least one transfer electrode, the mass analyser arrangement goes without the at least one transfer electrode. In such an alternative, the mass analyser arrangement can be constructed simpler and more cost effective. Eventually, in such an alternative, the method for mass analysing positively charged ions and negatively charged ions goes without generating the electric field with the at least one transfer electrode.

In the mass analyser arrangement, advantageously at least one of the first mass analyser and the second mass analyser is a time-of-flight mass analyser. Time-of-flight mass analysers have the advantage that they enable obtaining mass spectra with a very high mass to charge resolution. Thus, at least one of the first mass analyser and the second mass analyser being a time-of-flight mass analyser enables mass analysing the positively charged ions and/or negatively charged ions with a very high mass to charge resolution. In particular, in order to enable mass analysing the positively charged ions and the negatively charged ions with a very high mass to charge resolution, advantageously, both the first mass analyser and the second mass analyser are each a time-of-flight mass analyser.

In the context of mass analysing positively charged ions and negatively charged ions with a very high mass to charge resolution, the method according to the invention and the mass analyser arrangement according to the invention for mass analysing positively charged ions and negatively charged ions are particular advantageous because they enable the use of the full advantages of the first mass analyser being a time-of-flight mass analyser and the second mass analyser is a time-of-flight mass analyser for a bipolar mass analysis. One aspect for this advantage as compared to other bipolar mass analysis methods and arrangements is that time-of-flight-mass analysers require high voltages in the range of kV or even tens of kV for being operated. Due to these high voltages required, a fast switching of the polarity of a time-of-flight mass analyser would lead to breakdowns, flashovers and damages to the equipment. Thus, employing one single time-of-flight mass analyser and switching the polarity of this time-of-flight mass analyser would not allow for a fast switching between the polarities and would lead to long dead times where no ions at all can be mass analysed. This disadvantage is overcome with the method and mass analyser arrangement according to the present invention when employing a time-of-flight mass analyser as the first mass analyser and another time-of-flight mass analyser as the second mass analyser. Another aspect for the advantage as compared to other bipolar mass analysis methods and arrangements is that in a time-of-flight mass analyser, the high voltages need to be applied with a very high precision since deviations of 0.1 V in the applied voltages already lead to considerable errors in the obtained mass spectra. Thus, deviations in the applied voltages in the time-of-flight mass analyser caused by weak electric fields applied in the vicinity of a time-of-flight mass analyser, in particular in the vicinity of an inlet into a time-of-flight mass analyser, can easily lead to a significant reduction in the precision of the applied voltages such that considerable errors are introduced in the obtained mass spectra. Such weak electric fields applied in the vicinity of a time-of-flight mass analyser can be compensated for in the settings and the applied voltages in a time-of-flight mass analyser if the weak electric fields are well known and well defined. In case such weak electric fields change over time, any compensation is however difficult and prone to compensation mistakes such that despite the compensation efforts, considerable errors are introduced in the obtained mass spectra. This disadvantage can be overcome or at least strongly reduced with the method and the mass analyser arrangement according to the present invention when employing time-of-flight mass analysers as the first mass analyser and/or the second mass analyser because the positively charged ions and the negatively charged ions are inserted into the mass analysis chamber since this allows avoiding any switching of electric fields inside the mass analysis chamber. Thus, the above mentioned at least one transfer electrode is particular advantageous because it can be used to generate an electrostatic field for transferring the positively charged ions from the intake to the first mass analyser and the negatively charged ions from the intake to the second mass analyser. Consequently, the present invention enables to use time-of-flight mass analysers and profit of the high resolution mass spectra obtainable with time-of-flight mass analysers in bipolar mass analyser apparatuses.

In an advantageous variant, in case in the method and mass analyser arrangement according to the present invention, a first time-of-flight mass analyser is employed as the first mass analyser and a second time-of-flight mass analyser is employed as the second mass analyser, the first mass analyser is advantageously a first orthogonal time-of-flight mass analyser and the second mass analyser is advantageously a second orthogonal time-of-flight mass analyser.

Orthogonal time-of-flight mass analysers are known in the art. An orthogonal time-of-flight mass analyser is a time-of-flight mass analyser providing an extraction section, a mass separation section and an ion detector. For mass analysing ions with an orthogonal time-of-flight mass analyser, the ions are inserted along an initial direction of motion into a filling region. From this filling region, the ions are accelerated in the extraction section along an axis essentially perpendicular, in particular perpendicular, to the initial direction of motion of the ions to a kinetic energy. With this kinetic energy, the ions pass through the mass separation section and are detected with the ion detector. Thereby, a time-of-flight the ions require from being accelerated to reaching the ion detector is measured. Based on this measured times-of-flight, the mass-to-charge ratios of the ions are determined.

In orthogonal time-of-flight mass analysers, usually, the ions are inserted in a focused ion beam into the filling region. Thus, the filling region usually has essentially an elongated cylindrical shape. Thereby, the longitudinal axis of the cylindrical shape is usually oriented along the ion beam and the ions are inserted into the filling region along the longitudinal axis of the cylindrical shape. Consequently, the initial direction of motion of the ions is oriented along the longitudinal axis of the cylindrical shape of the filling region. Once the filling region is filled with ions, an electric field pulse is generated at least one extraction electrode in order to accelerate the ions away from the filling region. Thereby, the ions are accelerated in the extraction section along the axis essentially perpendicular, in particular perpendicular, to the initial direction of motion of the ions. Thus, the filling region is the space occupied by ions just before an electric field pulse is applied for accelerating the ions away from the filling region.

The electric field pulse has a duration in time which is sufficiently long to accelerate not only the ions with low mass-to-charge ratios but also the ions with higher mass-to-charge ratios during their passage of the extraction section. Thus, the ions obtain a kinetic energy as they pass during the electric field pulse from the filling region through the extraction section. For a particular ion, the kinetic energy obtained is proportional to the electric field strength of the electric field pulse at the position of the respective ion, proportional to the length of the extraction section and proportional to the number of elementary charges the particular ion has. Due to this kinetic energy, the speed the ions obtain in the direction along the axis essentially perpendicular, in particular perpendicular, to the initial direction of motion of the ions is proportional to the square root of the charge to mass ratio of the ions. For this reason, the ions are separated according to their mass-to-charge ration when passing the mass separation section. Thereby, the time-of-flight the ions require from being accelerated to reaching the ion detector is proportional to the square root of the mass to charge ratio of the ions. In case the first orthogonal time-of-flight mass analyser includes further acceleration electrodes for further accelerating the positively charged ions in the first mass separation section and in case the second orthogonal time-of-flight mass analyser includes further acceleration electrodes for further accelerating the positively charged ions in the second mass separation section or does not include such further acceleration electrodes, the positively charged ions and the negatively charged ions, respectively, may gain additional kinetic energy in the first mass separation section and second mass separation section, respectively, depending on the voltages applied to these further acceleration electrodes. This additional kinetic energy leads to a more pronounced separation of the ions according to their mass-to-charge ratio when passing the mass separation section. However, such an additional kinetic energy changes a scaling factor in the before mentioned relation according to which the time-of-flight the ions require from being accelerated away from the filling region to reaching the ion detector would be proportional to the square root of the mass-to-charge ratio of the ions. Nonetheless, the first orthogonal time-of-flight mass analyser and the second orthogonal time-of-flight mass analyser can easily by calibrated for accounting for this changed scaling factor.

During the electric field pulse, ions in the ion beam which are close to the filling region and which propagate towards the filling region are deviated from their initial direction of motion and thus neither enter the filling region and nor the extraction section. After the electric field pulse is over, however, the ions in the ion beam are no longer deviated and the filling region is thus again filled with ions, whereafter another electric field pulse is applied to the at least one extraction electrode.

Since the electric field pulses are very well reproducible, a starting point for the clock for measuring the time-of-flight the ions require from being accelerated to reaching the ion detector for determining the mass-to-charge ratios of the ions can be defined very precisely in relation to the electric field pulses. Furthermore, the electric field pulses being very well reproducible allows for a precise calibration of the orthogonal time-of-flight mass analyser despite the changing electric fields caused by the electric field pulses.

In case in the method and mass analyser arrangement according to the present invention, the first mass analyser is a first orthogonal time-of-flight mass analyser and the second mass analyser is a second orthogonal time-of-flight mass analyser, the first orthogonal time-of-flight mass analyser advantageously provides a first extraction section for accelerating the positively charged ions into a first mass separation section of the first time-of-flight mass analyser and the second orthogonal time-of-flight mass analyser advantageously provides a second extraction section for accelerating the negatively charged ions into a second mass separation section of the second time-of-flight mass analyser. Thereby, the first mass separation section may at least partially overlap the first extraction section, while the second mass separation section may at least partially overlap the second extraction section. Thereby, the first orthogonal time-of-flight mass analyser advantageously includes a first ion detector for detecting the positively charged ions after having passed the first mass separation section, while the second orthogonal time-of-flight mass analyser advantageously includes a second ion detector for detecting the negatively charged ions after having passed the second mass separation section. This has the advantage that high resolution mass spectra can be obtained with a high sensitivity from the positively charged ions and that high resolution mass spectra can be obtained with a high sensitivity from the negatively charged ions. This advantage can be achieved independent of whether the first orthogonal time-of-flight mass analyser includes further acceleration electrodes for further accelerating the positively charged ions in the first mass separation section or does not include such further acceleration electrodes and independent of whether the second orthogonal time-of-flight mass analyser includes further acceleration electrodes for further accelerating the positively charged ions in the second mass separation section or does not include such further acceleration electrodes.

Advantageously, the mass analyser arrangement provides a common filling region for the first orthogonal time-of-flight mass analyser and the second orthogonal time-of-flight mass analyser. Therefore, the positively charged ions and the negatively charged ions can be accelerated starting from one and the same common filling region towards the first mass separation section and towards the second mass separation section, respectively. As a result, the mass analyser arrangement can easily be constructed such that the relation in time of the moment when the positively charged ions are accelerated from the common filling region towards the first mass separation section as compared to moment when the negatively charged ions are accelerated from the common filling region towards the second mass separation section is well known if desired. Thus, it is easy to synchronise the probing of the positively charged ions and the probing of the negatively charged ions from an ion beam comprising the positively charged ions and the negatively charged ions. Even more, mass spectra of positively charged ions obtained with the first orthogonal time-of-flight mass analyser and mass spectra of negatively charged ions obtained with the second orthogonal time-of-flight mass analyser can easily be assigned to each other whenever they originate from one and the same extraction pulse or, if desired, whenever they originate from extraction pulses within a predefined time window. This assignment of mass spectra allows to access additional information about a sample in case the positively charged ions and the negatively charged ions originate from a same sample and have been ionised at a same time or even with one and the same ion source because this assignment of mass spectra enables and simplifies the identification of events in the sample affecting the distribution of the positively charged ions as well as the distribution of the negatively charged ions. Thus, the common filling region for the first orthogonal time-of-flight mass analyser and the second orthogonal time-of-flight mass analyser has the advantage that due to the simplified synchronisation of the probing of the positively charged ions and the probing of the negatively charged ions from an ion beam comprising the positively charged ions and the negatively charged ion, the enablement of the identification of events in the sample affecting the distribution of the positively charged ions as well as the distribution of the negatively charged ions is simplified because no complicated synchronisation of two independent mass analysers is required. Thus, the mass analyser arrangement can be constructed simpler and more cost effective and still enable the identification of events in the sample which affect the distribution of the positively charged ions as well as the distribution of the negatively charged ions.

Advantageously, the common filling region is located inside the mass analysis chamber. This has the advantage that the mass analyser arrangement can be constructed simpler.

Advantageously, the first extraction section is arranged from the common filling region in a first direction towards the first mass separation section, while the second extraction section is arranged from the common filling region in a second direction towards the second mass separation section. Thus, the first extraction section can overlap the filling region and partially overlap the second extraction section, while the second extraction section can overlap the filling region and partially overlap the first extraction section. Advantageously, the common filling region provides an elongated shape having a longitudinal axis along which the positively charged ions and the negatively charged ions are insertable via the intake into the common filling region, wherein the first direction is essentially orthogonal to this longitudinal axis and wherein the second direction is essentially orthogonal to this longitudinal axis. In an advantageous variant, the first direction is oriented opposite to the second direction. This has the advantage that the positively charged ions and the negatively charged ions can easily be accelerated by one and the same electric field pulse from the common filling region through the first extraction section and the second extraction section, respectively. Thus, the transferring the positively charged ions to the first mass analyser for mass analysing the positively charged ions and transferring of the negatively charged ions to the second mass analyser for mass analysing the negatively charged ions can be achieved with one single electric field pulse.

In case the mass analyser arrangement provides a common filling region for the first orthogonal time-of-flight mass analyser and the second orthogonal time-of-flight mass analyser, the method according to the invention advantageously includes the step of inserting the positively charged ions and the negatively charged ions into the common filling region before accelerating and thus transferring the positively charged ions to the first orthogonal time-of-flight mass analyser for mass analysing the positively charged ions and accelerating and thus transferring the negatively charged ions to the second orthogonal time-of-flight mass analyser for mass analysing the negatively charged ions.

In case the mass analyser arrangement provides the common filling region for the first orthogonal time-of-flight mass analyser and the second orthogonal time-of-flight mass analyser, the mass analyser arrangement advantageously includes at least one extraction electrode for generating electric field pulses for accelerating the positively charged ions in the first extraction section and the negatively charged ions in the second extraction section. This electric field pulse as sometimes also referred to as extraction pulse. In a first advantageous variant, the mass analyser arrangement includes at least one extraction electrode for generating electric field pulses for accelerating the positively charged ions in the first extraction section and at least one extraction electrode for generating the electrostatic the negatively charged ions in the second extraction section. This first variant has the advantage that the extraction of the positively charged ions from the common filling region and the extraction of the negatively charged ions from the common filling region can be controlled separately. In a second advantageous variant, the mass analyser arrangement includes at least one extraction electrode for generating electric field pulses for both accelerating the positively charged ions in the first extraction section and accelerating the negatively charged ions in the second extraction section. This second variant has the advantage that with one and the same pulse, the positively charged ions and the negatively charged ions can be extracted from the common filling region by accelerating the positively charged ions in the first extraction section and accelerating the negatively charged ions in the second extraction section. Consequently, this second variant has the advantage that the measurement of the time-of-flight of the positively charged ions and the measurement of the time-of-flight of the negatively charged ions can be started with one and the same electric field pulse.

In case the mass analyser arrangement includes at least one extraction electrode for generating electric field pulses for accelerating the positively charged ions in the first extraction section and the negatively charged ions in the second extraction section, the mass analyser arrangement advantageously includes a voltage pulse generation arrangement for applying voltage pulses to the at least one extraction electrode for generating the electric field pulses.

Advantageously, the mass analyser arrangement includes a time-of-flight determination arrangement providing two channels, whereof a first channel is for determining the time-of-flight the positively charged ions require to reach the first ion detector after an electric field pulse and a second channel is for determining the time-of-flight the negatively charged ions require to reach the second ion detector after an electric field pulse. Advantageously, this time-of-flight determination arrangement is connected to the first ion detector for receiving a first detector signal from the first ion detector and connected to the second ion detector for receiving a second detector signal from the second ion detector. Furthermore, the time-of-flight determination arrangement advantageously provides a clock and a clock starting module for starting the clock when an electric field pulse is generated by the at least one extraction electrode for measuring the time-of-flight the positively charged ions require to reach the first ion detector after the respective electric field pulse and for measuring the time-of-flight the negatively charged ions require to reach the second ion detector after the respective electric field pulse. Thereby, in a first variant, the clock starting module is adapted for providing a pulse generating command to the voltage pulse generation arrangement for applying a voltage pulse to the at least one extraction electrode for generating the respective electric field pulse and thereby to start at the same time the clock for measuring the time-of-flight the positively charged ions require to reach the first ion detector after the respective electric field pulse and for measuring the time-of-flight the negatively charged ions require to reach the second ion detector after the respective electric field pulse. In this first variant, the time-of-flight determination arrangement advantageously provides a pulse generating command output for providing the pulse generating command to the voltage pulse generation arrangement. In a second variant, the clock starting module is adapted for receiving a start signal indicating when an electric field pulse is or has been generated by the at least one extraction electrode and for, upon receipt of a start signal, starting the clock for measuring the time-of-flight the positively charged ions require to reach the first ion detector after the respective electric field pulse and for measuring the time-of-flight the negatively charged ions require to reach the second ion detector after the respective electric field pulse. In this second variant, the time-of-flight determination arrangement advantageously provides a start signal input for receiving a start signal indicating when an electric field pulse is or has been generated by the at least one extraction electrode. This start signal may be provided by the voltage pulse generation arrangement, by a control unit controlling the voltage pulse generation arrangement or by a pulse detection unit for detecting when an electric field pulse is or has been generated by the at least one extraction electrode. Thus, the mass analyser arrangement may include such a control unit for controlling the voltage pulse generation arrangement or such a pulse detection unit for detecting when an electric field pulse is or has been generated by the at least one extraction electrode.

The time-of-flight determination arrangement providing the two channels, the clock and the clock starting module as described above has the advantage that the time-of-flight the positively charged ions require to reach the first ion detector after an electric field pulse and the time-of-flight the negatively charged ions require to reach the second ion detector after an electric field pulse is measured with the same clock and thus determined with the same clock. Thus, the time-of-flight measurements of the positively charged ions and the negatively charged ions is synchronised due to the use of the same clock. Consequently, no complicated and expensive architecture for synchronising the time-of-flight measurements of the positively charged ions and the negatively charged ions is required. This advantage is particularly pronounced in case of the before mentioned second advantageous variant in which the mass analyser arrangement includes the at least one extraction electrode for applying electric field pulses for both accelerating the positively charged ions in the first extraction section and accelerating the negatively charged ions in the second extraction section because in this case, the architecture of the mass analyser arrangement intrinsically provides an optimal synchronisation of the time-of-flight measurements of the positively charged ions and the negatively charged ions.

In an example, the time-of-flight determination arrangement is a time-to-digital converter (TDC) having two channels. A TDC can for example be adapted to recognise the events when positively charged ions reach the first ion detector and to provide with the first channel a digital representation of the time these events occurred after the starting of the clock by the clock starting module. Thereby, the TDC can for example be adapted to recognise the events when negatively charged ions reach the second ion detector and to provide with the second channel a digital representation of the time these events occurred after the starting of the clock by the clock starting module.

In another example, the time-of-flight determination arrangement is an analog-to-digital converter (ADC) having two channels. An ADC can for example be adapted to convert in the first channel a continuous-time signal of the clock and the first detector signal being a continuous-amplitude analog signal of the first ion detector to a discrete-time discrete-amplitude signal of the first channel and to convert in the second channel the continuous-time signal of the clock and the second detector signal being a continuous-amplitude analog signal of the second ion detector to a discrete-time discrete-amplitude signal of the second channel.

Advantageously, each one of the at least one extraction electrode is one of the at least one transfer electrode. Thus, the number of transfer electrodes is advantageously the same as the number of extraction electrodes or larger than the number of extraction electrodes. This has the advantage that less electrodes are required in the mass analyser arrangement.

In an advantageous variant, the mass analyser arrangement includes at least two extraction electrodes. Advantageously, two of the at least two extraction electrodes are arranged on opposite sides of the common filling region. Thereby, advantageously, the two of the at least two extraction electrodes are adapted to be supplied with opposite voltage pulses for generating electric field pulses for both accelerating the positively charged ions in the first extraction section and accelerating the negatively charged ions in the second extraction section. Advantageously, a first one of the two of the at least two extraction electrodes is arranged on an opposite side of the first extraction section as compared to the common filling region, while a second one of the two of the at least two extraction electrodes is arranged on an opposite side of the second extraction section as compared to the common filling region. Thus, in this variant, the first extraction section, the filling region and the second extraction section are advantageously arranged between the two of the at least two extraction electrodes. In this arrangement, the first one of the two of the at least two extraction electrodes advantageously provides at least one hole for passing the accelerated positively charged ions through while the second one of the two of the at least two extraction electrodes advantageously provides at least one hole for passing the accelerated negatively charged ions through. In one example, the two of the at least two extraction electrodes are constructed from a grid. In another example, the extraction electrodes are however constructed without holes. This may for example be achieved by arranging two or more extraction electrodes besides each other with gaps in between for passing the ions through.

An arrangement of two of the at least two extraction electrodes on opposite sides of the common filling region is particular advantageous for generating electric field pulses for both accelerating the positively charged ions in the first extraction section and accelerating the negatively charged ions in the second extraction section in order to extract with one and the same pulse the positively charged ions and the negatively charged ions from the common filling region by accelerating the positively charged ions in the first extraction section and accelerating the negatively charged ions in the second extraction section.

Alternatively to these variants, however, other mass analysers than time-of-flight mass analysers can be employed as the first mass analyser and/or the second mass analyser. Examples of such other mass analysers are sector mass analysers, quadrupole mass analysers and Orbitraps.

Advantageously, the mass analyser arrangement is adapted for operating the mass analysis chamber at a gas pressure of less than 10⁻⁴ mbar, particular advantageously less than 10⁻⁵ mbar, during executing the method according to the invention for mass analysing the positively charged ions and the negatively charged ions with the mass analyser arrangement. Thus, the chamber housing is advantageously sufficient gas tight that with a suitable vacuum pump, a gas pressure of less than 10⁻⁴ mbar or less than 10⁻⁵ mbar, respectively, can be achieved and maintained in the mass analysis chamber. Thereby, the suitable vacuum pump may be included in the mass analyser arrangement or the mass analyser arrangement may include a connector for connecting an external suitable vacuum pump to the mass analyser arrangement. Such an external suitable vacuum pump may for example be part of a laboratory buildings' vacuum system. Thus, in an example, the connector of the mass analyser arrangement is connectable to a laboratory buildings' vacuum system.

Thus, in the method for mass analysing the positively charged ions and the negatively charged ions, advantageously, in the mass analysis chamber, a gas pressure of less than 10⁻⁴ mbar, particular advantageously less than 10⁻⁵ mbar, is maintained during inserting the positively charged ions and negatively charged ions via the intake into the mass analysis chamber of the mass analyser arrangement and transferring inside the mass analysis chamber the positively charged ions from the intake to the first mass analyser, mass analysing the positively charged ions with the first mass analyser, transferring inside the mass analysis chamber the negatively charged ions from the intake to the second mass analyser of the mass analyser arrangement and mass analysing the negatively charged ions with the second mass analyser.

Alternatively, however, a gas pressure of 10⁻⁴ mbar or more is maintained in the mass analysis chamber. In such an alternative, the mass analyser arrangement is adapted for operating the mass analysis chamber at a gas pressure of 10⁻⁴ mbar or more. When a higher gas pressure is accepted in the mass analysis chamber, less complex equipment or even no equipment is required for achieving and maintaining a reduced pressure in the mass analysis chamber.

Preferably, the mass analyser arrangement includes a switchable ion gate arranged in front of the intake for controlling an insertion of the positively charged ions and the negatively charged ions via the intake into the mass analysis chamber of the mass analyser arrangement for enabling mass analysis of the positively charged ions with the first mass analyser and the negatively charged ions with the second mass analyser. In that the switchable ion gate is arranged in front of the intake, the switchable ion gate is arranged outside of the mass analysis chamber in an ion path of the positively charged ions and the negatively charged ions leading into the mass analysis chamber. Thereby, in case the intake extends over a length along the ion path leading into the mass analysis chamber, the switchable ion gate can be located inside the intake, as long as it is arranged outside of the mass analysis chamber.

The switchable ion gate arranged in front of the intake for controlling the insertion of the positively charged ions and the negatively charged ions into the mass analysis chamber has the advantage that the insertion of the positively charged ions and the negatively charged ions into the mass analysis chamber can be controlled in a very efficient and effective way.

Alternatively, however, the switchable ion gate is not arranged in front of the intake for controlling an insertion of the positively charged ions and the negatively charged ions via the intake into the mass analysis chamber of the mass analyser arrangement for enabling mass analysis of the positively charged ions with the first mass analyser and said negatively charged ions with the second mass analyser. In one example of such an alternative, the switchable ion gate can for example be arranged inside the mass analysis chamber.

Advantageously, the switchable ion gate is adapted to be operated with an ion gate voltage having an absolute value of less than 20 V being applied to the switchable ion gate for controlling insertion of the positively charged ions and the negatively charged ions via the intake into the mass analysis chamber of the mass analyser arrangement for enabling mass analysis of the positively charged ions with the first mass analyser and the negatively charged ions with the second mass analyser. This has the advantage that ion gate voltage can easily be switched at very fast rates of up to 100 kHz or more with a comparably simple voltage supply and, in case the switchable ion gate is arranged in front of the intake, does not alter the electric fields inside the mass analysis chamber. Thus, the switchable ion gate is advantageously adapted to be switched at a switching rate of 10 Hz or more, 50 Hz or more, 100 Hz or more, 5 kHz or more, 20 kHz or more, or 66.6667 kHz or more, respectively, as described above for the method for mass analysing positively charged ions and negatively charged ions. In a variant however, the switchable ion gate is adapted to be switched at a switching rate of less than 10 Hz. For example, the switchable ion gate is adapted to be switched at a switching rate of 1 Hz, 0.1 Hz, 0.01 Hz or even 0.004 Hz.

In an alternative to these variants, the switchable ion gate is adapted to be operated with no ion gate voltage being applied or with an ion gate voltage having an absolute value of 20 V or more being applied to the switchable ion gate for controlling insertion of the positively charged ions and the negatively charged ions via the intake into the mass analysis chamber of the mass analyser arrangement for enabling mass analysis of the positively charged ions with the first mass analyser and the negatively charged ions with the second mass analyser.

Advantageously, the switchable ion gate is adapted for being switched between a positive ions insertion mode where the positively charged ions are allowed to pass through the intake into the mass analysis chamber while the negatively charged ions are prevented from passing through the intake into the mass analysis chamber, and a negative ions insertion mode where the negatively charged ions are allowed to pass through the intake into the mass analysis chamber while the positively charged ions are prevented from passing through the intake into the mass analysis chamber. Thereby, the switchable ion gate is preferably switchable between the positive ions insertion mode and the negative ion insertion mode by reversing a sign of the ion gate voltage applied to the switchable ion gate, wherein in both the positive ion insertion mode and the negative ion insertion mode, the ion gate voltage has an absolute value in a range from 1 V to about 10 V, particular preferably from 1 V to about 5 V. Thereby, the absolute value of the ion gate voltage may be the same in both the positive ion insertion mode and the negative ion insertion mode or may be different in the positive ion insertion mode as compared to in the negative ion insertion mode. In a variant, however, the switchable ion gate is switchable between the positive ions insertion mode and the negative ion insertion mode by reversing a sign of the ion gate voltage applied to the switchable ion gate, wherein in at least one of the positive ion insertion mode and the negative ion insertion mode, the ion gate voltage has an absolute value in of less than 1 V or more than 10 V.

Advantageously, the mass analyser arrangement includes an ion path housing section for housing a section of an ion path of the positively charged ions and the negatively charged ions leading to the switchable ion gate and via the switchable ion gate to the intake, wherein the ion path housing section enables achieving and maintaining inside the ion path housing section a gas pressure of 10⁻² mbar or less, in particular a gas pressure of 10⁻³ mbar or less. Thus, the ion path housing section is advantageously sufficiently gas tight that with a suitable vacuum pump, a gas pressure of 10⁻² mbar or less, or a gas pressure of 10⁻³ mbar or less, respectively, can be achieved and maintained inside the ion path housing section. Thereby, a suitable vacuum pump may be included in the mass analyser arrangement or the mass analyser arrangement may include a connector for connecting the mass analyser arrangement to an external suitable vacuum pump. Such an external suitable vacuum pump may for example be part of a laboratory buildings' vacuum system. Thus, in an example, the connector of the mass analyser arrangement is connectable to a laboratory buildings' vacuum system.

In the method for mass analysing the positively charged ions and the negatively charged ions, advantageously, in the ion path housing section of the mass analyser arrangement for housing the section of the ion path of the positively charged ions and the negatively charged ions leading to the ion gate and via the ion gate to the intake, a gas pressure of 10⁻² mbar or less, in particular a gas pressure of 10⁻³ mbar or less, is maintained during inserting the positively charged ions and negatively charged ions via the intake into the mass analysis chamber of the mass analyser arrangement. The ion path housing section for housing the section of an ion path of the positively charged ions and the negatively charged ions leading to the ion gate via the ion gate to the intake being operable at a gas pressure of 10⁻² mbar or less, or at a gas pressure of 10⁻³ mbar or less, respectively, has the advantage that the switchable ion gate can easily be operated at switching rates of 100 kHz or even higher without generating a plasma and thus without risking any breakdowns, flashovers and damages to the equipment.

Alternatively, however, a gas pressure of more than 10⁻² mbar is maintained in the housing section. In such an alternative, the mass analyser arrangement is adapted for operating the housing section at a gas pressure of more than 10⁻² mbar. When a higher gas pressure is accepted in the housing section, less complex equipment or even no equipment is required for achieving and maintaining a reduced pressure in the housing section.

Independent of whether the gas pressure in the housing section is maintained at more than 10⁻² mbar or less than 10⁻² mbar, whenever a gas pressure of more than about 10⁻³ mbar is maintained in the housing section while inside the mass analysis chamber a gas pressure is maintained which is lower than the gas pressure maintained in the housing section, a transport of the positively charged ions and the negatively charged ions via the intake into the mass analysis chamber is enabled because due to the pressure difference, a gas flow from the housing section through the intake into the mass analysis chamber is generated, wherein the positively charged ions and the negatively charged ions are conveyed by the gas flow via the intake into the mass analysis chamber.

As an alternative to the switchable ion gate being adapted for being switched between the positive ions insertion mode where the positively charged ions are allowed to pass through the intake into the mass analysis chamber while the negatively charged ions are prevented from passing through the intake into the mass analysis chamber, and the negative ions insertion mode where the negatively charged ions are allowed to pass through the intake into the mass analysis chamber while the positively charged ions are prevented from passing through the intake into the mass analysis chamber, the switchable ion gate is adapted for being switched between an insertion mode where the positively charged ions and the negatively charge ions are allowed to pass through the intake into the mass analysis chamber and a blocking mode where the positively charged ions and the negatively charged ions are prevented from passing through the intake into the mass analysis chamber. Such an alternative may be advantageous in case the positively charged ions and the negatively charged ions are transported at a same time with a gas flow through the intake into the mass analysis chamber for enabling mass analysis of the positively charged ions with the first mass analyser and the negatively charged ions with the second mass analyser. In such an alternative, the mass analyser arrangement is advantageously adapted for operating the switchable ion gate in a gas pressure of above 10⁻² mbar. Thereby, it is irrelevant whether the mass analyser arrangement includes the ion path housing section enabling achieving and maintaining inside the ion path housing section a gas pressure of 10⁻² mbar or less, in particular a gas pressure of 10⁻³ mbar or less, or not. In a variation, however, the mass analyser arrangement includes a reduced pressure housing section for housing a section of an ion path of the positively charged ions and the negatively charged ions leading to the ion gate and via the ion gate to the intake, the reduced pressure housing section enabling achieving and maintaining inside the reduced pressure housing section a gas pressure between 10⁻² mbar and one atmosphere.

In an alternative to these variants with the mass analyser arrangement including the switchable ion gate, the mass analyser arrangement goes without a switchable ion gate. Going without a switchable ion gate can for example be advantageous in case no gating of the positively charged ions and the negatively charged ions is required for insertion of the positively charged ions and the negatively charged ions because they are released already in a sufficient controlled manner by the at least one ion source which generates the positively charged ions and the negatively charged ions.

Independent of whether the mass analyser arrangement includes the switchable ion gate or not, the mass analyser arrangement preferably includes an ion trap for trapping the positively charged ions and/or the negatively charged ions, the ion trap being arranged in front of the intake into the mass analysis chamber. Thus, in the method for mass analysing the positively charged ions and the negatively charged ions, the positively charged ions and/or the negatively charged ions are preferable trapped in the ion trap of the mass analyser arrangement before being inserted via the intake into the mass analysis chamber of the mass analyser arrangement, the ion trap being arranged in front of the intake into the mass analysis chamber. Thereby, in that the ion trap is arranged in front of the intake, the ion trap is arranged outside of the mass analysis chamber in an ion path of the positively charged ions and the negatively charged ions leading into the mass analysis chamber. Thereby, in case the intake extends over a length along the ion path leading into the mass analysis chamber, the ion trap can be located inside the intake, as long as it is arranged outside of the mass analysis chamber.

In case the mass analyser arrangement includes the above described ion path housing section for housing the section of the ion path of the positively charged ions and the negatively charged ions to the ion gate and via the ion gate to the intake, wherein the housing section enables achieving and maintaining inside the ion path housing section a gas pressure of 10⁻² mbar or less, in particular a gas pressure of 10⁻³ mbar or less, the ion trap is advantageously arranged in the ion path housing section. In a variant, however, the ion trap is arranged outside of the housing section.

Advantageously, the ion trap includes a quadrupole electrode for generating a radiofrequency electromagnetic field for confining the positively charged ions and the negatively charged ions to a space along an axis of the ion trap. Thereby, the mass analyser arrangement advantageously includes a radiofrequency AC voltage source for applying a radiofrequency AC voltage to the quadrupole electrode for generating the radiofrequency electromagnetic field for confining the positively charged ions and the negatively charged ions to a space along an axis of the ion trap.

The mass analyser arrangement may however go without such a radiofrequency AC voltage source in case an external radiofrequency AC voltage source is used for applying the radiofrequency AC voltage to the quadrupole electrode for generating the radiofrequency electromagnetic field for confining the positively charged ions and the negatively charged ions to a space along an axis of the ion trap.

Accordingly, in the method for mass analysing the positively charged ions and the negatively charged ions, the radiofrequency AC voltage is advantageously applied to the quadrupole electrode for generating the radiofrequency electromagnetic field for confining the positively charged ions and the negatively charged ions to the space along an axis of the ion trap. Thereby, the radiofrequency AC voltage has preferably a maximum amplitude of less than 50 V, particular preferably less than 20 V, most preferably less than 10 V.

Employing the quadrupole electrode in the ion trap for generating the radiofrequency electromagnetic field has the advantage that the positively charged ions and the negatively charged ions can be confined in a very efficient way to the space along the axis of the ion trap. Thereby, such an ion trap with a quadrupole electrode has the advantage that only some lenses require voltages of about 50V. All the other voltages for operating the other electrodes of the ion trap can be operated at smaller voltages. Thus, the voltages of the ion trap can easily be switched with sufficient speed for operating the ion trap without influencing the electric in the mass analysis chamber. Furthermore, choosing the radiofrequency AC voltage applied to the quadrupole electrode having a maximum amplitude of less than 50 V, less than 20 V, or less than 10 V, respectively, has the advantage that the radiofrequency AC electromagnetic field generated by the quadrupole electrode is chosen to be comparably weak and to not affect the inside of the mass analysis chamber. Thus, any disturbance of the first mass analyser and the second mass analyser can be prevented. Thereby, of course, the weaker the maximum amplitude is, the less the inside of the mass analysis chamber is affected.

Alternatively to these variants, the radiofrequency AC voltage applied to the quadrupole electrode has a maximum amplitude of 50 V or more.

Advantageously, the ion trap includes at least one drive electrode for generating a reversible DC electric field along the axis of the ion trap for driving in one state of the DC electric field the positively charged ions to one end of the ion trap and the negatively charged ions to the other end of the ion trap and for driving in the reversed state of the DC electric field the negatively charged ions to the one end of the ion trap and the positively charged ions to the other end of the ion trap. Thereby, the mass analyser arrangement advantageously includes a DC voltage source for applying a reversible DC voltage to the at least one drive electrode for generating the reversible DC electric field along the axis of the ion trap for driving in the one state of the DC electric field the positively charged ions to one end of the ion trap and the negatively charged ions to the other end of the ion trap and for driving in the reversed state of the DC electric field the negatively charged ions to the one end of the ion trap and the positively charged ions to the other end of the ion trap. The mass analyser arrangement may however go without such a DC voltage source in case an external DC voltage source is used for applying the reversible DC voltage to the at least one drive electrode for generating the reversible DC electric field along the axis of the ion trap for driving in the one state of the DC electric field the positively charged ions to the one end of the ion trap and the negatively charged ions to the other end of the ion trap and for driving in the reversed state of the DC electric field the negatively charged ions to the one end of the ion trap and the positively charged ions to the other end of the ion trap.

Accordingly, in the method for mass analysing the positively charged ions and the negatively charged ions, advantageously, the reversible DC voltage is advantageously applied to the at least one drive electrode for generating the reversible DC electric field along the axis of the ion trap for driving in the one state of the DC electric field the positively charged ions to one end of the ion trap and the negatively charged ions to the other end of the ion trap and for driving in the reversed state of the DC electric field the negatively charged ions to the one end of the ion trap and the positively charged ions to the other end of the ion trap. Thereby, the reversible DC voltage has preferably a maximum amplitude of less than 50 V, particular preferably less than 20 V, most preferably less than 10 V. Employing the at least one drive electrode has the advantage that the positively charged ions and the negatively charged ions can be confined in a very efficient way to a space along the axis of the ion trap having a limited length along the axis of the ion trap.

In a variation to these variants with the at least one drive electrode, however, the ion trap may go without the at least one drive electrode.

Alternatively to these variants, the ion trap may go without the quadrupole electrode.

Advantageously, the switchable ion gate is arranged at one end of the ion trap for releasing the positively charged ions and/or the negatively charged ions in a controlled manner from the ion trap and thus controlling the insertion of the positively charged ions and the negatively charged ions via the intake into the mass analysis chamber of the mass analyser arrangement for enabling mass analysis of the positively charged ions with the first mass analyser and the negatively charged ions with the second mass analyser. This has the advantage that a controlled alternating insertion of the positively charged ions and the negatively charged ions into the intake of the mass analysis chamber can be achieved without losing positively charged ions or negatively charged ions, respectively, during times when the other ones of the positively charged ions and the negatively charged ions are inserted into the intake of the mass analysis chamber.

Alternatively, however, the switchable ion gate is arranged somewhere else than at one end of the ion trap.

Advantageously, the switchable ion gate and the ion trap are adapted to be operated with voltages of less than 200 V, preferably less than 100 V, for controlling the insertion of the positively charged ions and the negatively charged ions via the intake into the mass analysis chamber of the mass analyser arrangement for enabling mass analysis of the positively charged ions with the first mass analyser and the negatively charged ions with the second mass analyser.

Accordingly, in the method for mass analysing positively charged ions and negatively charged ions, the switchable ion gate and the ion trap are advantageously operated with voltages of less than 200 V, preferably less than 100 V, for controlling the insertion of the positively charged ions and the negatively charged ions via the intake into the mass analysis chamber of the mass analyser arrangement for enabling mass analysis of the positively charged ions with the first mass analyser and the negatively charged ions with the second mass analyser.

Operating the switchable ion gate and the ion trap with voltages of less than 200 V, preferably less than 100 V, for controlling the insertion of the positively charged ions and the negatively charged ions via the intake into the mass analysis chamber of the mass analyser arrangement for enabling mass analysis of the positively charged ions with the first mass analyser and the negatively charged ions with the second mass analyser has the advantage that a fast switching of the switchable ion gate at frequencies of up to 100 kHz is enabled without the danger of arching and without generating a plasma and thus without risking any breakdowns, flashovers and damages to the equipment. This is particularly advantageous in combination with at least one of the first mass analyser and the second mass analyser being a time-of-flight mass analyser because a typical measurement time of one mass spectrum from 0 Th to 300 Th requires about 10 μs. Thus, time-of-flight mass analyser typically enable obtaining mass spectra at a rate of 100 kHz, which corresponds to the switching rate enabled for the operation of the switchable ion gate. Consequently, the method and the mass analysis arrangement according to the invention are optimised for being used with time-of-flight mass analysers as the first mass analyser and/or the second mass analyser for profiting of the high mass-to-charge resolution achievable with time-of-flight mass analysers while at the same time, a switching between analysing the positively charged ions and the negatively charged ions at a switching rate of up to 10 kHz is enabled, thus enabling a bipolar mass analysis with very high time resolution for resolving changes in a sample from which the positively charged ions and the negatively charged ions are obtained.

Alternatively, however the switchable ion gate and the ion trap are operated with voltages of 200 V or more for controlling the insertion of the positively charged ions and the negatively charged ions via the intake into the mass analysis chamber of the mass analyser arrangement for enabling mass analysis of the positively charged ions with the first mass analyser and the negatively charged ions with the second mass analyser

Other advantageous embodiments and combinations of features come out from the detailed description below and the entirety of the claims.

### BRIEF DESCRIPTION OF THE DRAWINGS

The drawings used to explain the embodiments show:

FIG. 1 a simplified schematic view of an apparatus 1 for mass analysing a sample with a method for mass analysing the sample, wherein the apparatus includes a mass analyser arrangement according to the invention for mass analysing positively charged ions and negatively charged ions and wherein in the method for mass analysing the sample, the method according to the invention for mass analysing positively charged ions and negatively charged ions is employed, and

FIG. 2 a simplified schematic view of a mass analysis chamber together with a first orthogonal time-of-flight mass analyser and a second orthogonal time-of-flight mass analyser, the view being a cutout of a mass analyser arrangement according to the invention.

In the figures, the same components are given the same reference symbols.

### PREFERRED EMBODIMENTS

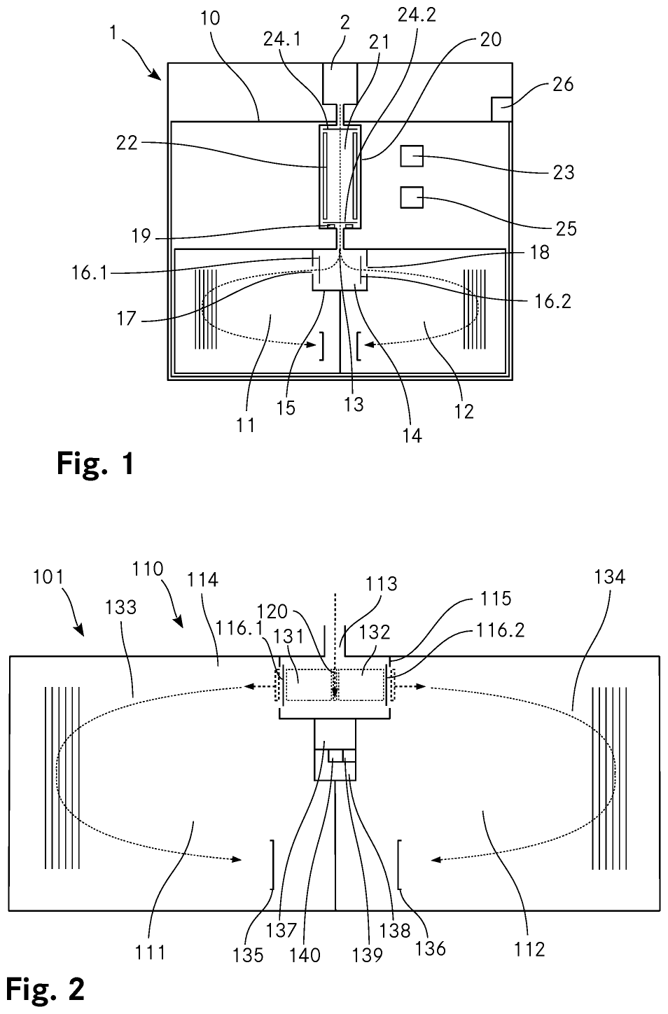

FIG. 1 shows a simplified schematic view of an apparatus 1 for mass analysing a sample with a method for mass analysing the sample. The apparatus 1 includes one ion source 2 for ionising the sample to positively charged ions and negatively charged ions. In a variant which is not shown here, the apparatus 1 includes a first ion source for generating the positively charged ions from the sample and a second ion source for generating the negatively charged ions from the sample. In this variant, an assay from the sample is fed to the first ion source and another assay from the sample is fed to the second ion source for ionising the sample to the positively charged ions and the negatively charged ions. In either variant, the one ion source or two ion sources include a sample inlet for inserting the sample into the respective ion source for being ionised to the positively charged ions and/or negatively charged ions, respectively.

Besides the one or more ion sources, the apparatus 1 includes a mass analyser arrangement 10 according to the invention for mass analysing the positively charged ions and the negatively charged ions with the method according to the invention for mass analysing the positively charged ions and the negatively charged ions. The mass analyser arrangement 10 includes a first mass analyser 11 and a second mass analyser 12 which are both time-of-flight mass analysers. In variants, one of the first mass analyser 11 and the second mass analyser 12 or both the first mass analyser 11 and the second mass analyser 12 are a different type of mass analyser than a time-of-flight mass analyser. Examples of different types of mass analysers are sector mass analysers, quadrupole mass analysers and Orbitraps.

The mass analyser arrangement 10 furthermore includes an intake 13 for inserting the positively charged ions and the negatively charged ions into a mass analysis chamber 14 of the mass analyser arrangement 10 for mass analysing the positively charged ions with the first mass analyser 11 and for mass analysing the negatively charged ions with the second mass analyser 12. Thereby, the intake 13 is fluidly coupled with the first mass analyser 11 for transferring the positively charged ions from the intake 13 to the first mass analyser 11 for mass analysing the positively charged ions. Furthermore, the intake 13 is fluidly coupled with the second mass analyser 12 for transferring the negatively charged ions from the intake 13 to the second mass analyser 12 for mass analysing the negatively charged ions. Thereby, the mass analyser arrangement 10 includes a chamber housing 15 surrounding the mass analysis chamber 14 and two transfer electrodes 16.1, 16.2 for generating an electrostatic field for transferring the positively charged ions inside the mass analysis chamber 14 from the intake 13 into a first mass analyser ion inlet 17 of the first mass analyser 11 and thus to the first mass analyser 11 for being mass analysed with the first mass analyser 11 and for transferring the negatively charged ions inside the mass analysis chamber 14 from the intake 13 into a second mass analyser ion inlet 18 of the second mass analyser 12 and thus to the second mass analyser 12 for being mass analysed with the second mass analyser 12. Both transfer electrodes 16.1, 16.2 are arranged inside the mass analysis chamber 14.

The mass analyser arrangement 10 is adapted for being operated with the mass analysis chamber 14 at a gas pressure of 8-10⁻⁵ mbar and thus less than 10⁻⁴ mbar during execution of the method according to the invention for mass analysing the positively charged ions and the negatively charged ions with the mass analyser arrangement 10. Thereby, the chamber housing 14 is sufficient gas tight that with a suitable vacuum pump, a gas pressure of 8-10⁻⁵ mbar and thus less than 10⁻⁴ mbar can be achieved and maintained in the mass analysis chamber 14. In a variant however, the mass analyser arrangement 10 is even adapted for being operated with the mass analysis chamber 14 at a gas pressure of 8·10⁻⁶ mbar and thus less than 10⁻⁵ mbar during executing the method according to the invention for mass analysing the positively charged ions and the negatively charged ions with the mass analyser arrangement 10. In this latter variant, the chamber housing 14 is sufficient gas tight that with a suitable vacuum pump, a gas pressure of 8·10⁻⁶ mbar and thus less than 10⁻⁵ mbar can be achieved and maintained in the mass analysis chamber 14.

In FIG. 1, no vacuum pump is shown because the vacuum pump is not required to be part of the mass analyser arrangement 10. More specifically, the vacuum pump may be included in the mass analyser arrangement 10 or the mass analyser arrangement 10 may include a connector for connecting an external suitable vacuum pump to the mass analyser arrangement 10. Such an external suitable vacuum pump may for example be part of a laboratory buildings' vacuum system or may be a mobile vacuum pump.

As visible in FIG. 1, the mass analyser arrangement 10 includes a switchable ion gate 19 arranged in front of the intake 13 for controlling an insertion of the positively charged ions and the negatively charged ions via the intake 13 into the mass analysis chamber 14 for enabling mass analysis of the positively charged ions with the first mass analyser 11 and mass analysis of the negatively charged ions with the second mass analyser 12. Thereby, the switchable ion gate 19 is adapted for being switched between a positive ions insertion mode where the positively charged ions are allowed to pass through the intake 13 into the mass analysis chamber 14 while the negatively charged ions are prevented from passing through the intake 13 into the mass analysis chamber 14, and a negative ions insertion mode where the negatively charged ions are allowed to pass through the intake 13 into the mass analysis chamber 14 while the positively charged ions are prevented from passing through the intake 13 into the mass analysis chamber 14. Thereby, the switchable ion gate 19 is switchable between the positive ions insertion mode and the negative ion insertion mode by reversing a sign of an ion gate voltage applied to the switchable ion gate 19, wherein in both the positive ion insertion mode and the negative ion insertion mode, the ion gate voltage has an absolute value of 4 V and thus in a range from 1 V to about 5 V. In a variant, the ion gate voltage has an absolute value of 8 V and thus in a range from 1 V to about 10 V. In either variant, the switchable ion gate 19 is thus adapted to be operated with an ion gate voltage having an absolute value of less than 20 V being applied to the switchable ion gate 19 for controlling insertion of the positively charged ions and the negatively charged ions via the intake 13 into the mass analysis chamber 14 for enabling mass analysis of the positively charged ions with the first mass analyser 11 and mass analysis of the negatively charged ions with the second mass analyser 12.

The mass analyser arrangement 10 furthermore includes an ion path housing section 20 for housing a section of an ion path of the positively charged ions and the negatively charged ions leading to the switchable ion gate 19 and via the switchable ion gate 19 to the intake 13, wherein the ion path housing section 20 enables achieving and maintaining inside the ion path housing section 20 a gas pressure of 10⁻² mbar or less. In a variant however, the ion path housing section 20 enables achieving and maintaining inside the ion path housing section 20 a gas pressure of 10⁻³ mbar or less. Thus, the ion path housing section 20 is sufficiently gas tight that with a suitable vacuum pump, a gas pressure of 10⁻² mbar or less, or a gas pressure of 10⁻³ mbar, respectively or less, respectively, can be achieved and maintained inside the ion path housing section 20. Again, in FIG. 1, no such vacuum pump is shown because the mass analyser arrangement 10 may include such a vacuum pump or may go without such a vacuum pump and include instead a connector for connecting the mass analyser arrangement 10 to an external suitable vacuum pump. Such an external suitable vacuum pump may for example be part of a laboratory buildings' vacuum system or may by a separate, mobile vacuum pump.

As visible in FIG. 1, the mass analyser arrangement 10 includes an ion trap 21 for trapping the positively charged ions and the negatively charged ions, the ion trap 21 being arranged in front of the intake 13 into the mass analysis chamber 14. The ion trap 21 is arranged inside the ion path housing section 20 as the switchable ion gate 19 is and is thus operated at the same gas pressure as the switchable ion gate 19 is.

The ion trap 21 includes a quadrupole electrode 22 for generating a radiofrequency electromagnetic field for confining the positively charged ions and the negatively charged ions to a space along an axis of the ion trap 21. Thereby, the mass analyser arrangement 10 includes a radiofrequency AC voltage source 23 for applying a radiofrequency AC voltage to the quadrupole electrode 22 for generating the radiofrequency electromagnetic field for confining the positively charged ions and the negatively charged ions to the space along the axis of the ion trap 21. This radiofrequency AC voltage has a maximum amplitude of 9 V and thus less than 10 V. In a variant however, the radiofrequency AC voltage has a maximum amplitude of 19 V and thus less than 20 V. In yet another variant, the radiofrequency AC voltage has a maximum amplitude of 45 V and thus less than 50 V.

The ion trap 21 furthermore includes two drive electrodes 24.1, 24.2 for generating a reversible DC electric field along the axis of the ion trap 21 for driving in one state of the DC electric field the positively charged ions to one end of the ion trap 21 and the negatively charged ions to the other end of the ion trap 21 and for driving in the reversed state of the DC electric field the negatively charged ions to the one end of the ion trap 21 and the positively charged ions to the other end of the ion trap 21. Thereby, the mass analyser arrangement 10 includes a DC voltage source 25 for applying a reversible DC voltage to the two drive electrodes 24.1, 24.2 for generating the reversible DC electric field along the axis of the ion trap 21 for driving in the one state of the DC electric field the positively charged ions to one end of the ion trap 1 and the negatively charged ions to the other end of the ion trap 21 and for driving in the reversed state of the DC electric field the negatively charged ions to the one end of the ion trap 21 and the positively charged ions to the other end of the ion trap 21. The reversible DC voltage has a maximum amplitude of 5 V and thus less than 10 V. In a variant, the reversible DC voltage has a maximum amplitude of 19 V and thus less than 20 V. In yet another variant, the reversible DC voltage has a maximum amplitude of 48 V and thus less than 50 V. Thus, the switchable ion gate 19 and the ion trap 21 are both adapted to be operated with voltages of less than 200 V and even less than 100 V for controlling the insertion of the positively charged ions and the negatively charged ions via the intake 13 into the mass analysis chamber 14 for enabling mass analysis of the positively charged ions with the first mass analyser 11 and mass analysis of the negatively charged ions with the second mass analyser 12. Thus, in the method according to the invention for mass analysing positively charged ions and negatively charged ions with the mass analyser arrangement 10, the switchable ion gate 19 and the ion trap 21 are operated with voltages of less than 200 V, even less than 100 V, for controlling the insertion of the positively charged ions and the negatively charged ions via the intake 13 into the mass analysis chamber 14 for enabling mass analysis of the positively charged ions with the first mass analyser 11 and mass analysis of the negatively charged ions with the second mass analyser 12.

As visible in FIG. 1, the switchable ion gate 19 is arranged at one end of the ion trap 21 for releasing the positively charged ions and the negatively charged ions in a controlled manner from the ion trap 21 and thus controlling the insertion of the positively charged ions and the negatively charged ions via the intake 13 into the mass analysis chamber 14 of the mass analyser arrangement 10 for enabling mass analysis of the positively charged ions with the first mass analyser 11 and mass analysis of the negatively charged ions with the second mass analyser 12.

In the mass analysis arrangement 10, the switchable ion gate 19 is adapted for a fast switching. More precisely, the ion gate voltage can easily be switched at rates of up to 100 kHz or more with a comparably simple voltage supply and, which does not alter the electric fields inside the mass analysis chamber 14 because the switchable ion gate 19 is arranged in front of the intake 13 and not inside the mass analysis chamber 14. More precisely, the switchable ion gate 19 is adapted to be switched at switching rates of 0.004 Hz, 0.01 Hz, 0.1 Hz, 1 Hz, 10 Hz, 50 Hz, 100 Hz, 5 kHz, 20 kHz, 66.6667 kHz and 100 kHz.

When executing the method according to the invention for mass analysing the positively charged ions and the negatively charged ions with the mass analyser arrangement 10 shown in FIG. 1, the method includes inserting the positively charged ions and the negatively charged ions via the intake 13 into the mass analysis chamber 14 of the mass analyser arrangement 10, and transferring inside the mass analysis chamber 14 the positively charged ions from the intake 13 to the first mass analyser 11 and mass analysing the positively charged ions with the first mass analyser 11 and transferring inside the mass analysis chamber 14 the negatively charged ions from the intake 13 to the second mass analyser 12 and mass analysing the negatively charged ions with the second mass analyser 12. Thereby, the insertion of the positively charged ions and the negatively charged ions via the intake 13 into the mass analysis chamber 14 is controlled with the switchable ion gate 19, wherein the switchable ion gate 19 is switched between the positive ions insertion mode where the positively charged ions are allowed to pass through the intake 13 into the mass analysis chamber 14 while the negatively charged ions are prevented from passing through the intake 13 into the mass analysis chamber 14 and the negative ions insertion mode where the negatively charged ions are allowed to pass through the intake 13 into the mass analysis chamber 14 while the positively charged ions are prevented from passing through the intake 13 into the mass analysis chamber 14. Thereby, depending on the needs of the specific measurement, the switchable ion gate 19 is switched between the positive ions insertion mode and the negative ions insertion mode and back within 250 s, 100 s, 10 s, 1 s, 100 ms, 20 ms, 10 ms, 200 μs, 50 μs or 15 μs or even less. Switching between the positive ions insertion mode and the negative ions insertion mode and back within 100 ms or less has the advantage that the method for mass analysing the positively charged ions and the negatively charged ions enables a time resolved mass analysis of positively charged ions and negatively charged ions obtained by ionisation from an output of a gas chromatography column, wherein the time resolution is sufficient for obtaining the gas chromatogram from the gas chromatography column, too. Switching between the positive ions insertion mode and the negative ions insertion mode and back within 20 ms or less has the advantage that the method for mass analysing the positively charged ions and the negatively charged ions enables a time resolved mass analysis of positively charged ions and negatively charged ions obtained by ionisation from an output of a fast gas chromatography column, wherein the time resolution is sufficient for obtaining the gas chromatogram from the fast gas chromatography column, too.

Furthermore, switching between the positive ions insertion mode and the negative ions insertion mode and back within 20 ms or less has the advantage that the method for mass analysing the positively charged ions and the negatively charged ions enables a time resolved mass analysis of positively charged ions and negatively charged ions obtained by ionisation from a gaseous sample at atmospheric pressure, wherein the time resolution is sufficient for resolving changes in the gaseous sample, too. Switching between the positive ions insertion mode and the negative ions insertion mode and back within 10 ms or less has the advantage that the method for mass analysing the positively charged ions and the negatively charged ions enables a time resolved mass analysis of positively charged ions and negatively charged ions obtained by ionisation from an output of an ion molecule reactor at a pressure of 50 mbar, wherein the time resolution is sufficient for resolving changes in the output of the ion molecule reactor, too.

Switching between the positive ions insertion mode and the negative ions insertion mode and back within 200 μs or less has the advantage that the method for mass analysing the positively charged ions and the negatively charged ions enables a time resolved mass analysis of positively charged ions and negatively charged ions where at least one of the positively charged ions and the negatively charged ions are separated according to their mobility in an ion mobility separation chamber, wherein the time resolution is sufficient for obtaining the ion mobility spectrum of the positively charged ions and/or negatively charged ions, respectively, too.

Switching between the positive ions insertion mode and the negative ions insertion mode and back within 50 μs or less, in particular or 15 μs or less, has the advantage that the method for mass analysing the positively charged ions and the negatively charged ions enables obtaining with a high time resolution and very high time resolution, respectively, for analysing any time dependent changes in a sample. Too short switching times however may become disadvantageous as well. For example, switching the switchable ion gate 19 between the positive ions insertion mode and the negative ions insertion mode and back after a longer time period than 10 μs can be advantageous because this ensures that a mass spectra from 0 Th to at least 300 Th can be obtained with the first mass analyser 11 and the second mass analyser 12.

Switching the switchable ion gate 19 between the positive ions insertion mode and the negative ions insertion mode and back after a longer time period than 32 μs can as well be advantageous because it ensures that a mass spectra from 0 Th to at least 3'000 Th can be obtained with the first mass analyser 11 and the second mass analyser 12.

In the method for mass analysing the positively charged ions and the negatively charged ions with the mass analyser arrangement 10, the above mentioned electrostatic field is generated with the two transfer electrodes 16.1, 16.2 for transferring the positively charged ions inside the mass analysis chamber 14 from the intake 13 to the first mass analyser 11 for being mass analysed with the first mass analyser 11 and for transferring the negatively charged ions inside the mass analysis chamber 14 from the intake 13 to the second mass analyser 12 for being mass analysed with the second mass analyser 12. Furthermore, for mass analysing the positively charged ions and the negatively charged ions, a gas pressure of 8-10⁻⁶ mbar and thus less than 10⁻⁵ mbar or, in a variant, 8·10⁻⁵ mbar and thus less than 10⁻⁴ mbar, is maintained in the mass analysis chamber 14 during inserting the positively charged ions and negatively charged ions via the intake 13 into the mass analysis chamber 14 and during transferring the positively charged ions inside the mass analysis chamber 14 from the intake 13 to the first mass analyser 11 and mass analysing the positively charged ions with the first mass analyser 11 and during transferring the negatively charged ions inside the mass analysis chamber 14 from the intake 13 to the second mass analyser 12 and mass analysing the negatively charged ions with the second mass analyser 12. Furthermore, in the ion path housing section 20, a gas pressure of 10⁻² mbar or less, in particular a gas pressure of 10⁻³ mbar or less, is maintained during inserting the positively charged ions and negatively charged ions via the intake 13 into the mass analysis chamber 14.

In the method, before being inserted via the intake 13 into the mass analysis chamber 14, the positively charged ions and the negatively charged ions are trapped in the ion trap 21 in that the radiofrequency AC voltage is applied to the quadrupole electrode 22 for generating the radiofrequency electromagnetic field for confining the positively charged ions and the negatively charged ions to the space along an axis of the ion trap 21 and in that the reversible DC voltage is applied to the two drive electrodes 24.1, 24.2 and repeatedly reversed for generating the reversible DC electric field along the axis of the ion trap 21 for driving in the one state of the DC electric field the positively charged ions to one end of the ion trap 21 and the negatively charged ions to the other end of the ion trap 21 and for driving in the reversed state of the DC electric field the negatively charged ions to the one end of the ion trap 21 and the positively charged ions to the other end of the ion trap 21. Thereby, the reversible DC voltage is reversed at a rate which corresponds to the switching rate of the switchable ion gate 19 such that the ion trap 21 and the switchable ion gate 19 are synchronised. Every time when the reversible DC voltage is such that the DC electric field drives the positively charged ions in the ion trap 21 to the end of the ion trap 21 where the switchable ion gate 19 is located, the switchable ion gate 19 is switched to the positive ions insertion mode such that the positively charged ions are inserted into via the intake 13 into the mass analysis chamber 14. And every time when the reversible DC voltage is reversed such that the DC electric field is reversed and drives the negatively charged ions in the ion trap 21 to the end of the ion trap 21 where the switchable ion gate 19 is located, the switchable ion gate 19 is switched to the negative ions insertion mode such that the negatively charged ions are inserted into via the intake 13 into the mass analysis chamber 14.

In the apparatus 1 shown in FIG. 1, the ion source 2 is fluidly coupled to the intake 13 for transferring the positively charged ions and the negatively charged ions, respectively, from the ion source 2 to the intake 13 for inserting the positively charged ions and the negatively charged ions into the mass analysis chamber 14 for enabling the mass analysis of the positively charged ions with the first mass analyser 11 and for enabling the mass analysis of the negatively charged ions with the second mass analyser 12. Thereby, since the mass analysis arrangement 10 includes the ion trap 21 and the switchable ion gate 19, the ion source 2 is even fluidly coupled to the intake 13 for transferring the positively charged ions and the negatively charged ions, respectively, from the ion source 2 via the ion trap 21 and the switchable ion gate 19 to the intake 13 for inserting the positively charged ions and the negatively charged ions into the mass analysis chamber 14.

As mentioned, the apparatus 1 is for mass analysing a sample with a method for mass analysing the sample. Thereby, in the method for mass analysing the sample, the sample is ionised with the ion source 2 to positively charged ions and negatively charged ions. After this ionisation, the positively charged ions and the negatively charged ions are mass analysed with the mass analyser arrangement 10 of the apparatus 1 with the method according to the invention for mass analysing positively charged ions and negatively charged ions with the mass analyser arrangement 10 as described.

The apparatus 1 shown in FIG. 1 includes a control unit 26 adapted to control the apparatus 1 for executing the method for mass analysing the sample. Thereby, the control unit 26 is at the same part of the mass analyser arrangement 10 and adapted for controlling the mass analyser arrangement 10 for executing the method according to the invention for mass analysing positively charged ions and negatively charged ions. The control unit 26 may be a personal computer or any other computing device adapted for executing the respective method. Thereby, the instructions for executing the respective method may be hard wired in the computing device or may be a computer software running on the computing device. In a variant, however, the apparatus 1 goes without control unit 1. In this case, the apparatus 1 is connectable to a separate control unit like a personal computer for being operated and controlled to execute the method for analysing the sample.

In the mass analyser arrangement 10 of the apparatus 1 shown in FIG. 1, the first mass analyser 11 and a second mass analyser 12 are both time-of-flight mass analysers. Thereby, the first mass analyser and the second mass analyser can for example both be orthogonal time-of-flight mass analysers. In order to illustrate such a variant with the first mass analyser and the second mass analyser both being orthogonal time-of-flight mass analysers, FIG. 2 shows a simplified schematic view of a mass analysis chamber 114 together with a first orthogonal time-of-flight mass analyser 111 and a second orthogonal time-of-flight mass analyser 112. Thus, FIG. 2 essentially shows a cutout of a mass analyser arrangement 110 according to the invention which includes the mass analysis chamber 114, the first orthogonal time-of-flight mass analyser 111 and the second orthogonal time-of-flight mass analyser 112.

The mass analyser arrangement 110 of FIG. 2 includes a chamber housing 115 surrounding the mass analysis chamber 114 and an intake 113 for inserting the positively charged ions and the negatively charged ions into the mass analysis chamber 114 where the positively charged ions are transferred to the first orthogonal time-of-flight mass analyser 111 for mass analysing the positively charged ions with the first orthogonal time-of-flight mass analyser 111 and where the negatively charged ions are transferred to the second orthogonal time-of-flight mass analyser 112 for mass analysing the negatively charged ions with the second orthogonal time-of-flight mass analyser 112. With this mass analyser arrangement 110, the method according to the invention for mass analysing positively charged ions and negatively charged ions can be employed. Thereby, the mass analyser arrangement 110 can be part of an apparatus 101 for mass analysing a sample with a method for mass analysing the sample as described above in the context of FIG. 1. Of course, the mass analyser 110 can include one or more of the further elements described in the context of FIG. 1. For example, the mass analyser arrangement 110 includes the switchable ion gate arranged in front of the intake 113 and the ion trap even though they are not shown in FIG. 2. Similarly, the apparatus 101 can include one or more of the further elements like the one or more than one ion source for ionising the sample to positively charged ions and negatively charged ions.

The first orthogonal time-of-flight mass analyser 111 of the mass analyser arrangement 110 of FIG. 2 provides a first extraction section 131 for accelerating the positively charged ions into a first mass separation section 133 of the first time-of-flight mass analyser 111. Furthermore, the second orthogonal time-of-flight mass analyser 112 of the mass analyser arrangement 110 of FIG. 2 provides a second extraction section 132 for accelerating the negatively charged ions into a second mass separation section 134 of the second time-of-flight mass analyser 112.

Between the first extraction section 131 and the second extraction section 132, the mass analyser arrangement 110 of FIG. 2 provides a common filling region 120 for the first orthogonal time-of-flight mass analyser 111 and the second orthogonal time-of-flight mass analyser 112. This common filling region 120 is located in the mass analysis chamber 114, wherein the first extraction section 131 is arranged from the common filling region 120 in a first direction towards the first mass separation section 133, while the second extraction section 132 is arranged from the common filling region 120 in a second direction towards the second mass separation section 134. Thereby, the first direction is oriented opposite to the second direction.

When the positively charged ions and the negatively charged ions are inserted via the intake 113 into the mass analysis chamber 114, they enter the common filling region 120 as an ion beam. Thereby, the ion beam entering the common filling region 120 may comprise a homogeneous mixture of the positively charged ions and the negatively charged ions, may comprise sections with positively charged ions and sections with negatively charged ions or may comprise one section of positively charged ions or one section of negatively charged ions. In either case, the common filling region 120 has essentially an elongated cylindrical shape, wherein the longitudinal axis of the cylindrical shape is oriented along the ion beam. Thus, the ions are inserted into the common filling region 120 along the longitudinal axis of the cylindrical shape of the common filling region 120.

In case the switchable ion gate is adapted for being switched between a positive ions insertion mode where the positively charged ions are allowed to pass through the intake 113 into the mass analysis chamber 114 while the negatively charged ions are prevented from passing through the intake 113 into the mass analysis chamber 114, and a negative ions insertion mode where the negatively charged ions are allowed to pass through the intake 113 into the mass analysis chamber 114 while the positively charged ions are prevented from passing through the intake 113 into the mass analysis chamber 114, the ion beam inserted via the intake 113 into the mass analysis chamber 114 comprises along its length sections with positively charged ions and sections with negatively charged ions. As a consequence, depending on how fast the switchable ion gate is switched between the positive ions insertion mode and the negative ions insertion mode, the common filling region 120 is filled with several sections of positively charged ions and several sections of negatively charged ions or is only filled with one section or a part of a section of positively charge ions or is only filled with one section or a part of a section of negatively charged ions.

On the other hand, in case the switchable ion gate is adapted for allowing positively charged ions and negatively charged ions pass at the same time through the intake 113 into the mass analysis chamber 114, the ion beam inserted via the intake 113 into the mass analysis chamber 114 comprises a homogeneous mixture of the positively charged ions and the negatively charged ions.

Once the common filling region 120 is filled with the positively charged ions and the negatively charged ions, only the positively charged ions or only the negatively charged ions, the ions are extracted from the common filling region 120 towards the respective one of the first orthogonal time-of-flight mass analyser 111 and the second orthogonal time-of-flight mass analyser 112. In order to achieve this extraction, the mass analyser arrangement 110 includes two extraction electrodes 116.1, 116.2 for generating electric field pulses for accelerating the positively charged ions in the first extraction section 131 and the negatively charged ions in the second extraction section 132. Thereby, the first extraction section 131, the common filling region 120 and the second extraction section 132 are arranged between the two extraction electrodes 116.1, 116.2.

More precisely, a first one of the two extraction electrodes 116.1 is arranged on the side of the first orthogonal time-of-flight mass analyser 111, while the second one of the two extraction electrodes 116.2 is arranged on the side of the second orthogonal time-of-flight mass analyser 112 of the first extraction section 131, the common filling region 120 and the second extraction section 132. The two extraction electrodes 116.1, 116.2 are both made from a grid providing openings for letting pass the accelerated positively charged ions and the accelerated negatively charged ions through the openings of the respective one of the two extraction electrodes 116.1, 116.2 into the first mass separation section 133 and the second mass separation section 134, respectively. Thus, the mass analyser arrangement 110 includes two extraction electrodes 116.1, 116.2 for generating electric field pulses for both accelerating the positively charged ions in the first extraction section 131 and accelerating the negatively charged ions in the second extraction section 132. As a result of this geometry, the positively charged ions and the negatively charged ions can be accelerated starting from one and the same common filling region 120 towards the first mass separation section 133 and towards the second mass separation section 134, respectively.

In order to generate the electric field pulses for extracting the positively charged ions from the common filling region 120 and accelerating the positively charged ions in the first extraction region 131 and for extracting the negatively charged ions from the common filing region 120 and accelerating the negatively charged ions in the second extraction region 132, the mass analyser arrangement 110 includes a voltage pulse generation arrangement 137 for applying voltage pulses to the two extraction electrodes 116.1, 116.2 for generating the electric field pulses. For this reason, the voltage pulse generation arrangement 137 is connected to the two extraction electrodes 116.1, 116.2 in order to apply voltage pulses having opposite signs to the two extraction electrodes 116.1, 116.2. More precisely, for generating one extraction pulse, a negative voltage pulse is applied to the first extraction electrode 116.1 while at the same time, a positive voltage pulse having the same strength as the negative voltage pulse is applied to the second extraction electrode 116.2, such that the positively charged ions are accelerated to the first extraction electrode 116.1 while the negatively charged ions are accelerated to the second extraction electrode 116.2.

Due to this functionality of the two extraction electrodes 116.1, 116.2, the two extraction electrodes 116.1, 116.2 are transfer electrodes for generating an electric field, in particular an electrostatic field, for transferring the positively charged ions inside the mass analysis chamber 114 from the intake 113 to the first orthogonal time-of-flight mass analyser 111 for being mass analysed with the first orthogonal time-of-flight mass analyser 111 and for transferring the negatively charged ions inside the mass analysis chamber 114 from the intake 113 to the second orthogonal time-of-flight mass analyser 112 for being mass analysed with the second orthogonal time-of-flight mass analyser 112.

The first orthogonal time-of-flight mass analyser 111 includes a first ion detector 135 for detecting the positively charged ions after they have passed the first mass separation section 133, while the second orthogonal time-of-flight mass analyser 112 includes a second ion detector 136 for detecting the negatively charged ions after they have passed the second mass separation section 134. In order to measure the time-of-flight the positively charged ions require to reach the first ion detector 135 after an electric field pulse generated by the two extraction electrodes 116.1, 116.2 and in order to measure the time-of-flight the negatively charged ions require to reach the second ion detector 136 after an electric field pulse generated by the two extraction electrodes 116.1, 116.2, the mass analyser arrangement 110 includes a time-of-flight determination arrangement 138 providing two channels. A first channel of these two channels is for determining the time-of-flight the positively charged ions require to reach the first ion detector 135 after an electric field pulse and a second channel of these two channels is for determining the time-of-flight the negatively charged ions require to reach the second ion detector 136 after an electric field pulse. Thereby, the time-of-flight determination arrangement 138 is connected to the first ion detector 135 for receiving a first detector signal from the first ion detector 135 and connected to the second ion detector 136 for receiving a second detector signal from the second ion detector 136.

The time-of-flight determination arrangement 138 provides a clock 139 and a clock starting module 140 for starting the clock 139 when an electric field pulse is generated by the two extraction electrodes 116.1, 116.2 for measuring the time-of-flight the positively charged ions require to reach the first ion detector 135 after the respective electric field pulse and for measuring the time-of-flight the negatively charged ions require to reach the second ion detector 136 after the respective electric field pulse. In order to enable these time-of-flight measurements, the time-of-flight determination arrangement 138 provides a start signal input for receiving a start signal from the voltage pulse generation arrangement 137 indicating when a voltage pulse is applied to the two extraction electrodes 116.1, 116.2 and thus when an electric field pulse is generated by the two extraction electrodes 116.1, 116.2. Upon receipt of this start signal, the clock starting module 140 starts the clock 139 such that the time-of-flight the positively charged ions require to reach the first ion detector 135 after the respective electric field pulse and the time-of-flight the negatively charged ions require to reach the second ion detector 136 after the respective electric field pulse can be determined with the time-of-flight determination arrangement 138 based on the first detector signal received from the first ion detector 135 and the second detector signal received from the second ion detector 136 indicating the moments when ions arrive at the respective one of the first ion detector 135 and the second ion detector 136.

In the embodiment shown in FIG. 2, the time-of-flight determination arrangement 138 is an analog-to-digital converter (ADC) having two channels. It is adapted to convert in the first channel a continuous-time signal of the clock 139 and the first detector signal being a continuous-amplitude analog signal of the first ion detector 135 to a discrete-time discrete-amplitude signal of the first channel and to convert in the second channel the continuous-time signal of the clock 139 and the second detector signal being a continuous-amplitude analog signal of the second ion detector 136 to a discrete-time discrete-amplitude signal of the second channel.

The invention is not limited to the embodiments described in the context of FIG. 1. Other embodiments, variants and variations are readily available to the person skilled in the art.

In summary, it is to be noted that a method and a mass analyser arrangement pertaining to the technical field initially mentioned are created, that provide more freedom to the ionisation method used for generating the positively charged ions and the negatively charged ions.

1. A method for mass analysing positively charged ions and negatively charged ions with a mass analyser arrangement, said method including
a) inserting said positively charged ions and said negatively charged ions via an intake of said mass analyser arrangement into a mass analysis chamber of said mass analyser arrangement, and
b) transferring inside said mass analysis chamber said positively charged ions from said intake to a first mass analyser of said mass analyser arrangement and mass analysing said positively charged ions with said first mass analyser and transferring inside said mass analysis chamber said negatively charged ions from said intake to a second mass analyser of said mass analyser arrangement and mass analysing said negatively charged ions with said second mass analyser.

2. The method according to claim 1, wherein insertion of said positively charged ions and said negatively charged ions via said intake into said mass analysis chamber is controlled with a switchable ion gate of said mass analyser arrangement, wherein said switchable ion gate is arranged in front of said intake, wherein said switchable ion gate is switched between
a) a positive ions insertion mode where said positively charged ions are allowed to pass through said intake into said mass analysis chamber while said negatively charged ions are prevented from passing through said intake into said mass analysis chamber, and
b) a negative ions insertion mode where said negatively charged ions are allowed to pass through said intake into said mass analysis chamber while said positively charged ions are prevented from passing through said intake into said mass analysis chamber.

3. The method according to claim 2, wherein said switchable ion gate is switched between said positive ions insertion mode and said negative ions insertion mode and back within 100 ms or less, preferably within 20 ms or less, particular preferably within 10 ms or less, more preferably within 200 μs or less, even more preferably within 50 μs or less, and most preferably within 15 μs or less.

4. A method for mass analysing a sample, wherein said sample is ionised with at least one ion source to positively charged ions and negatively charged ions, wherein said positively charged ions and said negatively charged ions are mass analysed with the method according to claim 1.

5. A mass analyser arrangement for mass analysing positively charged ions and negatively charged ions with the method according to claim 1, said mass analyser arrangement including
a) a first mass analyser for mass analysing said positively charged ions,
b) a second mass analyser for mass analysing said negatively charged ions, and
c) an intake for inserting said positively charged ions and said negatively charged ions into a mass analysis chamber of said mass analyser arrangement for mass analysing said positively charged ions with said first mass analyser and for mass analysing said negatively charged ions with said second mass analyser, wherein said intake is fluidly coupled with said first mass analyser for transferring said positively charged ions from said intake to said first mass analyser for mass analysing said positively charged ions and wherein said intake is fluidly coupled with said second mass analyser for transferring said negatively charged ions from said intake to said second mass analyser for mass analysing said negatively charged ions.

6. The mass analyser arrangement according to claim 5, wherein said mass analyser arrangement includes a chamber housing surrounding said mass analysis chamber.

7. The mass analyser arrangement according to claim 5, wherein said mass analyser arrangement includes at least one transfer electrode for generating an electric field for transferring said positively charged ions inside said mass analysis chamber from said intake to said first mass analyser for being mass analysed with said first mass analyser and for transferring said negatively charged ions inside said mass analysis chamber from said intake to said second mass analyser for being mass analysed with said second mass analyser.

8. The mass analyser arrangement according to claim 5, wherein at least one of said first mass analyser and said second mass analyser is a time-of-flight mass analyser.

9. The mass analyser arrangement according to claim 5, wherein said mass analyser arrangement includes a switchable ion gate arranged in front of said intake for controlling an insertion of said positively charged ions and said negatively charged ions via said intake into said mass analysis chamber of said mass analyser arrangement for enabling mass analysis of said positively charged ions with said first mass analyser and said negatively charged ions with said second mass analyser.

10. The mass analyser arrangement according to claim 9, wherein said switchable ion gate is adapted for being switching between a positive ions insertion mode where said positively charged ions are allowed to pass through said intake into said mass analysis chamber while said negatively charged ions are prevented from passing through said intake into said mass analysis chamber, and a negative ions insertion mode where said negatively charged ions are allowed to pass through said intake into said mass analysis chamber while said positively charged ions are prevented from passing through said intake into said mass analysis chamber.

11. The mass analyser arrangement according to claim 10, wherein said mass analyser arrangement includes an ion path housing section for housing a section of an ion path of said positively charged ions and said negatively charged ions leading to said switchable ion gate and via said switchable ion gate to said intake, wherein said ion path housing section enables achieving and maintaining inside said ion path housing section a gas pressure of 10⁻² mbar or less.

12. The mass analyser arrangement according to claim 5, wherein said mass analyser arrangement includes an ion trap for trapping said positively charged ions and/or said negatively charged ions, said ion trap being arranged in front of said intake into said mass analysis chamber.

13. The mass analyser arrangement according to claim 9 or according to claim 12, wherein said switchable ion gate is arranged at one end of said ion trap for releasing said positively charged ions and/or said negatively charged ions in a controlled manner from said ion trap and thus controlling said insertion of said positively charged ions and said negatively charged ions via said intake into said mass analysis chamber of said mass analyser arrangement for enabling mass analysis of said positively charged ions with said first mass analyser and said negatively charged ions with said second mass analyser.

14. The mass analyser arrangement according to claim 13, wherein said switchable ion gate and said ion trap are operable with voltages of less than 200 V for controlling an insertion of said positively charged ions and said negatively charged ions via said intake into said mass analysis chamber of said mass analyser arrangement for enabling mass analysis of said positively charged ions with said first mass analyser and said negatively charged ions with said second mass analyser.

15. An apparatus for mass analysing a sample with the method according to claim 4, said apparatus including
a) at least one ion source for ionising said sample to positively charged ions and negatively charged ions and
b) the mass analyser arrangement of claim 5, the mass analyser arrangement including the first mass analyser and the intake for inserting said positively charged ions and said negatively charged ions into said mass analysis chamber of said mass analyser arrangement,
wherein said at least one ion source is fluidly coupled to said intake for transferring said positively charged ions and said negatively charged ions, respectively, from said at least one ion source to said intake for inserting said positively charged ions and said negatively charged ions into the mass analysis chamber of the mass analyser arrangement for enabling the mass analysis of said positively charged ions with the first mass analyser and for enabling the mass analysis of said negatively charged ions with the second mass analyser.

16. The method according to claim 3, wherein said switchable ion gate is switched between said positive ions insertion mode and said negative ions insertion mode and back within preferably within 10 ms or less.

17. The method according to claim 3, wherein said switchable ion gate is switched between said positive ions insertion mode and said negative ions insertion mode and back within 200 μs or less.

18. The method according to claim 3, wherein said switchable ion gate is switched between said positive ions insertion mode and said negative ions insertion mode and back within preferably within 15 μs or less.

19. The mass analyser arrangement according to claim 11, wherein said ion path housing section enables achieving and maintaining inside said ion path housing section a gas pressure of 10⁻³ mbar or less.

20. The mass analyser arrangement according to claim 14, wherein said switchable ion gate and said ion trap are operable with voltages of less than 100 V for controlling an insertion of said positively charged ions and said negatively charged ions via said intake into said mass analysis chamber of said mass analyser arrangement for enabling mass analysis of said positively charged ions with said first mass analyser and said negatively charged ions with said second mass analyser.
